(19) United States
(12) Patent Application Publication
(10) Pub. No.: US 2002/0007382 A1
(43) Pub. Date: Jan. 17, 2002

(54) Computer having character input function,method of carrying out process depending on input characters, and storage medium

(76) Inventors: Shinichi Nojima, Kawasaki (JP); Manabu Nanba, Nagaoka (JP); Toshio Oshima, Nagaoka (JP); Shinji Onzuka, Kawasaki (JP)

Correspondence Address: STAAS & HALSEY LLP, 700 11TH STREET, NW, SUITE 500, WASHINGTON, DC, 20001, US

(21) Appl. No.: 09/769,380

(22) Filed: Jan. 26, 2001

(30) Foreign Application Priority Data
Jul. 6, 2000 (JP) 2000-205339

(51) Int. Cl. G06F 17/21

(52) U.S. Cl. 707/532

(57) ABSTRACT

A computer has a character input function, and is provided with a detecting section which detects a keyword specified by one or more input characters, a display section which displays a menu screen indicating registered dictionaries when the keyword is detected, and an issuing section which issues a search request for dictionary data specified by the keyword in a dictionary which is selected as a search target on the menu screen with respect to a dictionary search program.

### BACKGROUND OF THE INVENTION

This application claims the benefit of a Japanese Patent Application No.2000-205339 filed Jul. 6, 2000, in the Japanese Patent Office, the disclosure of which is hereby incorporated by reference.

1. Field of the Invention

The present invention generally relates to computers, processing methods and storage media, and more particularly to a computer having a character input function and capable of carrying out a process depending on the input characters, a method of carrying out a process depending on the input characters, and a computer-readable storage medium which stores a program for causing the computer to carry out such a process depending on the input characters.

2. Description of the Related Art

When using a computer having a character input function such as that of a word processor to create or edit a document, the user (or operator) may wish to look up the meaning of a word in a dictionary, to look for synonyms of a word, to look for a translation of a word in a foreign language, or to carry out various operations by using a word as a keyword. For example, the keyword may be used to acquire information from a Web page on the internet, to access a home page of a certain company, to transmit an electronic mail to a certain person, or to start a certain program.

But in the conventional computer having the character input function, a program which enables the characters to be input and programs for carrying out the above described operations requested by the user are not linked to each other.

For this reason, when the user is using a first program having the character input function and wishes to look up the meaning of a word in a dictionary, for example, the operation using the first program having the character input function is interrupted, and a second program for looking up the meaning of the word in the dictionary is started. Then, an operation of inputting the characters of the word and instructing processing of the word are carried out in the second program, so as to search for the meaning of the word which is input.

Accordingly, in the conventional computer having the character input function, when another desired operation such as that described above and related to the characters which are being input needs to be carried out, the operation using the first program having the character input function must be interrupted, and the second program must be started so as to carry out the desired operation, because the first program and the second program are not linked to each other.

As a result, the user must interrupt the operation using the first program having the character input function every time another desired operation related to the characters which are being input and using the second program or the like other than the first program is to be carried out. Consequently, there was a problem in that a work using the first program having the character input function cannot be carried out efficiently since the operation using the first program must be interrupted every time a desired operation related to the characters which are being input and using the program other than the first program is to be carried out.

### SUMMARY OF THE INVENTION

Accordingly, it is a general object of the present invention to provide a novel and useful computer having a character input function, a method of carrying out a process depending on input characters, and a computer-readable storage medium, in which the problem described above is eliminated.

Another and more specific object of the present invention is to provide computer having a character input function, a method of carrying out a process depending on input characters, and a computer-readable storage medium, which can carry out a desired operation related to characters which are being input by a character input function, without interrupting the operation of the character input function.

Still another object of the present invention is to provide a computer having a character input function, comprising a detecting section detecting a keyword which is specified by one or more input characters, a display section displaying a menu screen indicating registered dictionaries when the keyword is detected by the detecting section, and an issuing section issuing a search request for dictionary data specified by the keyword in a dictionary which is selected as a search target on the menu screen with respect to a dictionary search program. According to the computer of the present invention, when the user wishes to confirm the meaning or the like of the keyword using a dictionary, it is possible to look up the dictionary without having to carry out an inconvenient operation of once interrupting the running program which has the character input function and then starting another program.

The issuing section may issue the search request for the dictionary data specified by the keyword, with respect to a plurality of dictionaries which are selected as search targets during a time when a define instruction is made to define the input characters.

The computer may further comprise an ending section ending a started program in response to a selection made on the menu screen when a define instruction is made to define the input characters.

A further object of the present invention is to provide a computer having a character input function, comprising a detecting section detecting a keyword which is specified by one or more input characters, a display section displaying a menu screen indicating registered programs when the keyword is detected by the detecting section, and a starting section starting a program which is selected on the menu screen while specifying the keyword or an attribute value corresponding to the keyword as a parameter. According to the computer of the present invention, when the user wishes to use the keyword to search a Web page on the internet, access a home page of a company having a company name indicated by the keyword or, send an electronic mail to a person having a name indicated by the keyword, it is possible to carry out such operations without having to carry out an inconvenient operation of once interrupting the running program which has the character input function and then starting another program.

The computer may further comprise a registering section registering data of a corresponding relationship of the keyword and the corresponding attribute value, according to an interactive process.

The display section may display a program which cannot be started by the keyword on the menu screen with a format which indicates that the program cannot be started.

The computer may further comprise an ending section ending a started program in response to a selection made on the menu screen when a define instruction is made to define the input characters.

Another object of the present invention is to provide a computer having a character input function, comprising a detecting section detecting a keyword which is specified by one or more input characters, a display section displaying a menu screen used for starting a program corresponding to the keyword when the keyword is detected by the detecting section, and a starting section starting the program corresponding to the keyword when a program start request is issued using the menu screen. According to the computer of the present invention, when the user wishes to start a desired program while inputting characters, it is possible to start the program without having to carry out an inconvenient operation of once interrupting the running program which has the character input function and then starting the desired program.

The computer may further comprise a registering section registering data of a corresponding relationship of the keyword and the program, according to an interactive process.

The computer may further comprise an ending section ending a started program in response to a selection made on the menu screen when a define instruction is made to define the input characters.

Still another object of the present invention is to provide a computer having a character input function, comprising a detecting section detecting a keyword which is specified by one or more input characters, a display section displaying a menu screen indicating registered conversion programs when the keyword is detected by the detecting section, and a starting section starting a conversion program which is selected using the menu screen to subject the keyword to a conversion according to the selected conversion program. According to the computer of the present invention, when the user wishes to acquire a converted data such as a synonym of the keyword, it is possible to acquire the converted data without having to carry out an inconvenient operation of once interrupting the running program which has the character input function and then starting another program.

The display section may display a conversion program which cannot convert the keyword on the menu screen with a format which indicates that the program cannot convert.

The computer may further comprise an ending section ending a started program in response to a selection made on the menu screen when a define instruction is made to define the input characters.

A further object of the present invention is to provide a computer having a character input function, comprising a detecting section detecting a keyword which is specified by one or more input characters, a display section displaying a menu screen in response to a predetermined operation in a state where the keyword is detected by the detecting section, and an executing section executing a process using the keyword depending on an item selected on the menu screen. According to the computer of the present invention, when the user wishes to carry out an operation on the keyword, it is possible to carry out the operation without having to carry out an inconvenient operation of once interrupting the running program which has the character input function and then starting another program.

Another object of the present invention is to provide a method of carrying out a process depending on input characters, comprising the steps of (a) detecting a keyword which is specified by one or more input characters, (b) displaying a menu screen indicating registered dictionaries when the keyword is detected by the step (a), and (c) issuing a search request for dictionary data specified by the keyword in a dictionary which is selected as a search target on the menu screen with respect to a dictionary search program. According to the method of the present invention, when the user wishes to confirm the meaning or the like of the keyword using a dictionary, it is possible to look up the dictionary without having to carry out an inconvenient operation of once interrupting the running program which has the character input function and then starting another program.

Still another object of the present invention is to provide a method of carrying out a process depending on input characters, comprising the steps of (a) detecting a keyword which is specified by one or more input characters, (b) displaying a menu screen indicating registered programs when the keyword is detected by the step (a), and (c) starting a program which is selected on the menu screen while specifying the keyword or an attribute value corresponding to the keyword as a parameter. According to the method of the present invention, when the user wishes to use the keyword to search a Web page on the internet, access a home page of a company having a company name indicated by the keyword or, send an electronic mail to a person having a name indicated by the keyword, it is possible to carry out such operations without having to carry out an inconvenient operation of once interrupting the running program which has the character input function and then starting another program.

A further object of the present invention is to provide a method of carrying out a process depending on input characters, comprising the steps of (a) detecting a keyword which is specified by one or more input characters, (b) displaying a menu screen used for starting a program corresponding to the keyword when the keyword is detected by the step (a), and (c) starting the program corresponding to the keyword when a program start request is issued using the menu screen. According to the method of the present invention, when the user wishes to start a desired program while inputting characters, it is possible to start the program without having to carry out an inconvenient operation of once interrupting the running program which has the character input function and then starting the desired program.

Another object of the present invention is to provide a method of carrying out a process depending on input characters, comprising the steps of (a) detecting a keyword which is specified by one or more input characters, (b) displaying a menu screen indicating registered conversion programs when the keyword is detected by the step (a), and (c) starting a conversion program which is selected using the menu screen to subject the keyword to a conversion according to the selected conversion program. According to the method of the present invention, when the user wishes to acquire a converted data such as a synonym of the keyword, it is possible to acquire the converted data without having to carry out an inconvenient operation of once interrupting the running program which has the character input function and then starting another program.

Still another object of the present invention is to provide a method of carrying out a process depending on input characters, comprising the steps of (a) detecting a keyword which is specified by one or more input characters, (b) displaying a menu screen in response to a predetermined operation in a state where the keyword is detected by the step (a), and (c) executing a process using the keyword depending on an item selected on the menu screen. According to the method of the present invention, when the user wishes to carry out an operation on the keyword, it is possible to carry out the operation without having to carry out an inconvenient operation of once interrupting the running program which has the character input function and then starting another program.

A further object of the present invention is to provide a computer-readable storage medium which stores a character input program for causing a computer to have a character input function, the character input program comprising a detecting procedure causing the computer to detect a keyword which is specified by one or more input characters, a display procedure causing the computer to display a menu screen indicating registered dictionaries when the keyword is detected by the detecting procedure, and an issuing procedure causing the computer to issue a search request for dictionary data specified by the keyword in a dictionary which is selected as a search target on the menu screen with respect to a dictionary search program. According to the computer-readable storage medium of the present invention, when the user wishes to confirm the meaning or the like of the keyword using a dictionary, it is possible to look up the dictionary without having to carry out an inconvenient operation of once interrupting the running program which has the character input function and then starting another program.

Another object of the present invention is to provide a computer-readable storage medium which stores a character input program for causing a computer to have a character input function, the character input program comprising a detecting procedure causing the computer to detect a keyword which is specified by one or more input characters, a display procedure causing the computer to display a menu screen indicating registered programs when the keyword is detected by the detecting procedure, and a starting procedure causing the computer to start a program which is selected on the menu screen while specifying the keyword or an attribute value corresponding to the keyword as a parameter. According to the computer-readable storage medium of the present invention, when the user wishes to use the keyword to search a Web page on the internet, access a home page of a company having a company name indicated by the keyword or, send an electronic mail to a person having a name indicated by the keyword, it is possible to carry out such operations without having to carry out an inconvenient operation of once interrupting the running program which has the character input function and then starting another program.

Still another object of the present invention is to provide a computer-readable storage medium which stores a character input program for causing a computer to have a character input function, the character input program comprising a detecting procedure causing the computer to detect a keyword which is specified by one or more input characters, a display procedure causing the computer to display a menu screen used for starting a program corresponding to the keyword when the keyword is detected by the detecting procedure, and a starting procedure causing the computer to start the program corresponding to the keyword when a program start request is issued using the menu screen. According to the computer-readable storage medium of the present invention, when the user wishes to start a desired program while inputting characters, it is possible to start the program without having to carry out an inconvenient operation of once interrupting the running program which has the character input function and then starting the desired program.

A further object of the present invention is to provide a computer-readable storage medium which stores a character input program for causing a computer to have a character input function, the character input program comprising a detecting program causing the computer to detect a keyword which is specified by one or more input characters, a display procedure causing the computer to display a menu screen indicating registered conversion programs when the keyword is detected by the detecting procedure, and a starting procedure causing the computer to start a conversion program which is selected using the menu screen to subject the keyword to a conversion according to the selected conversion program. According to the computer-readable storage medium of the present invention, when the user wishes to acquire a converted data such as a synonym of the keyword, it is possible to acquire the converted data without having to carry out an inconvenient operation of once interrupting the running program which has the character input function and then starting another program.

Another object of the present invention is to provide a computer-readable storage medium which stores a character input program for causing a computer to have a character input function, the character input program comprising a detecting procedure causing the computer to detect a keyword which is specified by one or more input characters, a display procedure causing the computer to display a menu screen in response to a predetermined operation in a state where the keyword is detected by the detecting procedure, and an executing procedure causing the computer to execute a process using the keyword depending on an item selected on the menu screen. According to the computer-readable storage medium of the present invention, when the user wishes to carry out an operation on the keyword, it is possible to carry out the operation without having to carry out an inconvenient operation of once interrupting the running program which has the character input function and then starting another program.

Other objects and further features of the present invention will be apparent from the following detailed description when read in conjunction with the accompanying drawings.

### BRIEF DESCRIPTION OF THE DRAWINGS

FIG. 1 is a diagram for explaining a system applied with a computer according to the present invention;

FIG. 2 is a system block diagram showing a hardware structure of the computer;

FIG. 3 is a diagram showing a bridge menu;

FIG. 4 is a diagram showing an embodiment of the computer according to the present invention;

FIGS. 5A and 5B respectively are diagrams for explaining a file structure of a search site address definition file;

FIGS. 6A and 6B respectively are diagrams for explaining a file structure of a home page address definition file;

FIGS. 7A and 7B respectively are diagrams for explaining a file structure of a mail address definition file;

FIGS. 8A and 8B respectively are diagrams for explaining a file structure of a program path definition file;

FIG. 9 is a diagram for explaining a common file structure;

FIG. 10 is a diagram for explaining an interactive screen;

FIG. 11 is a flow chart for explaining an internet search process carried out by a Kana-Kanji converting section;

FIG. 12 is a flow chart for explaining the internet search process carried out by the KanaKanji converting section;

FIGS. 13A and 13B respectively are flow charts for explaining a home page inspection process carried out by the Kana-Kanji converting section;

FIGS. 14A and 14B respectively are flow charts for explaining a quick Japanese-English translation process carried out by the Kana-Kanji converting section;

FIGS. 15A and 15B respectively are flow charts for explaining a quick single Kanji translation process carried out by the Kana-Kanji converting section;

FIGS. 16A and 16B respectively are flow charts for explaining a date conversion process carried out by the Kana-Kanji converting section;

FIGS. 17A and 17B respectively are flow charts for explaining a dictionary search process carried out by the Kana-Kanji converting section;

FIG. 18 is a flow chart for explaining a dictionary search process carried out by a dictionary search application;

FIG. 19 is a flow chart for explaining the dictionary search process carried out by the KanaKanji converting section;

FIG. 20 is a flow chart for explaining the dictionary search process carried out by the dictionary search application;

FIGS. 21A and 21B respectively are diagrams for explaining a method of converting a URL of a search site;

FIG. 22 is a diagram for explaining a screen displaying search information related to an undefined character string and obtained from a search site;

FIG. 23 is a diagram for explaining a screen displaying a home page corresponding to the undefined character string;

FIG. 24 is a diagram for explaining a mail sending screen displaying a destination mail address corresponding to the undefined character string;

FIG. 25 is a diagram for explaining a program processing screen;

FIG. 26 is a diagram for explaining a character input screen;

FIG. 27 is a diagram for explaining a menu item selection on the screen;

FIG. 28 is a diagram for explaining a screen displaying dictionary data;

FIG. 29 is a diagram for explaining a screen displaying dictionary data;

FIG. 30 is a diagram for explaining a menu item selection on the screen;

FIG. 31 is a diagram for explaining a screen displaying dictionary data;

FIG. 32 is a diagram for explaining a dictionary search process;

FIG. 33 is a diagram for explaining the dictionary search process;

FIG. 34 is a diagram for explaining the dictionary search process; and

FIG. 35 is a diagram for explaining the dictionary search process.

### DESCRIPTION OF THE PREFERRED EMBODIMENTS

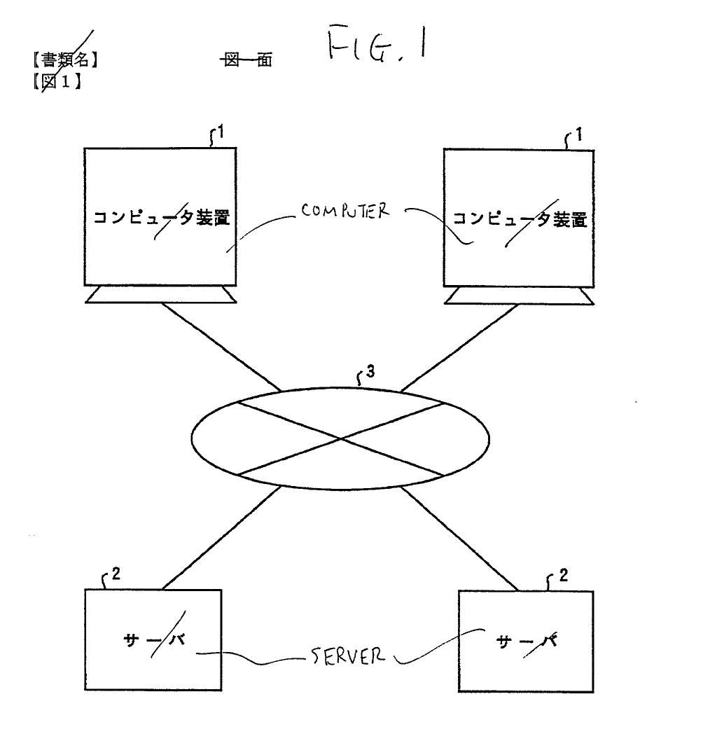

FIG. 1 is a diagram for explaining a system applied with a computer according to the present invention. As shown in FIG. 1, each computer 1 according to the present invention may be coupled to a server 2 via a network 3.

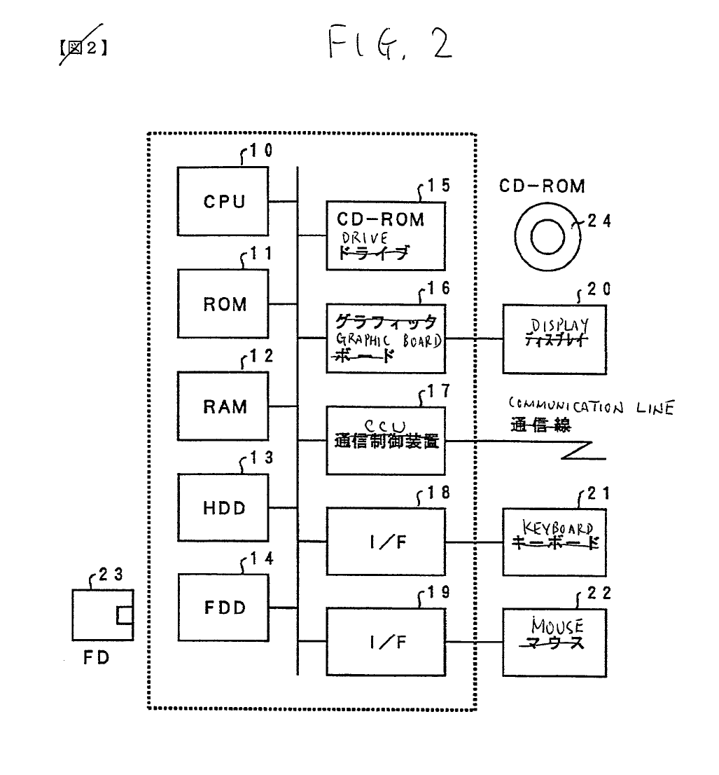

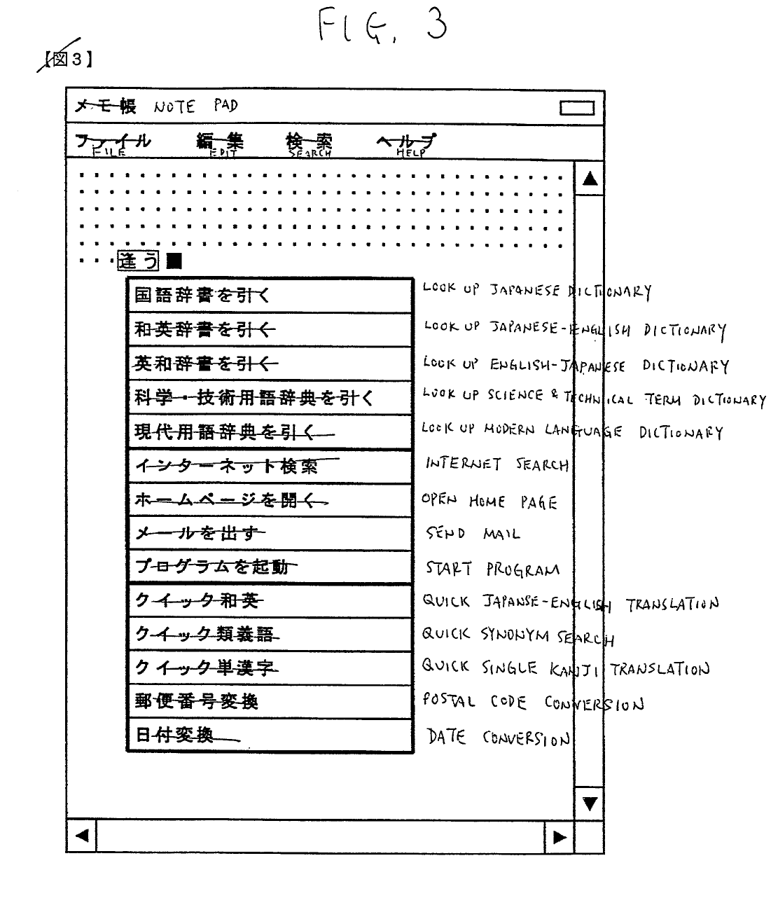

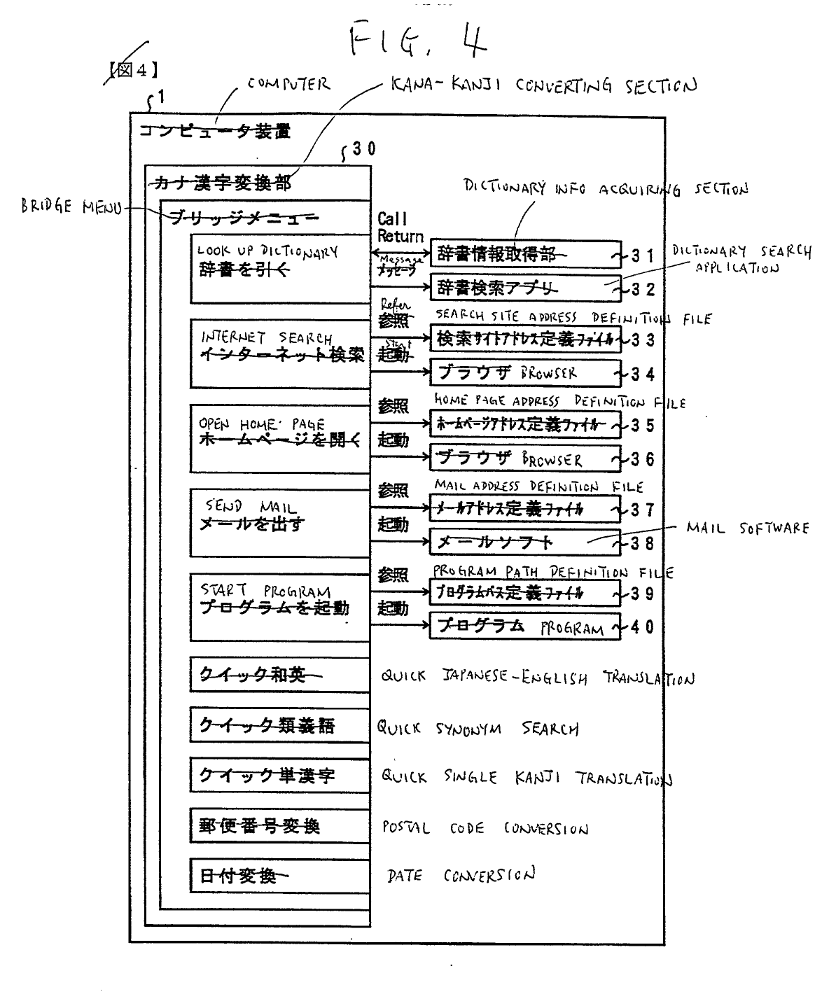

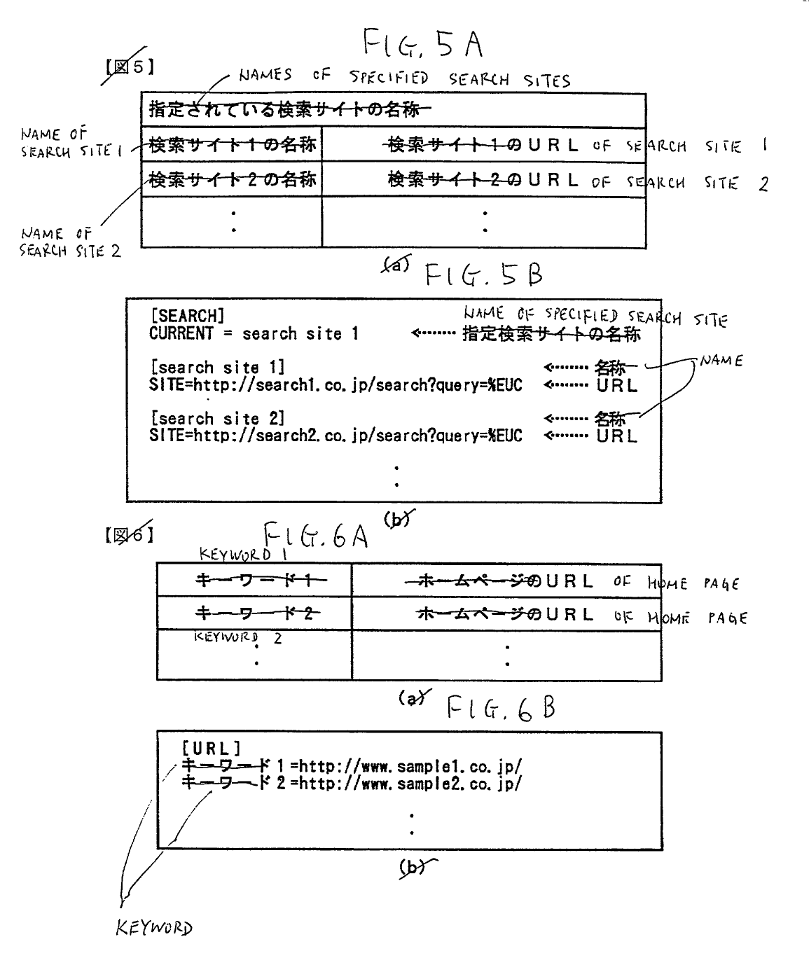

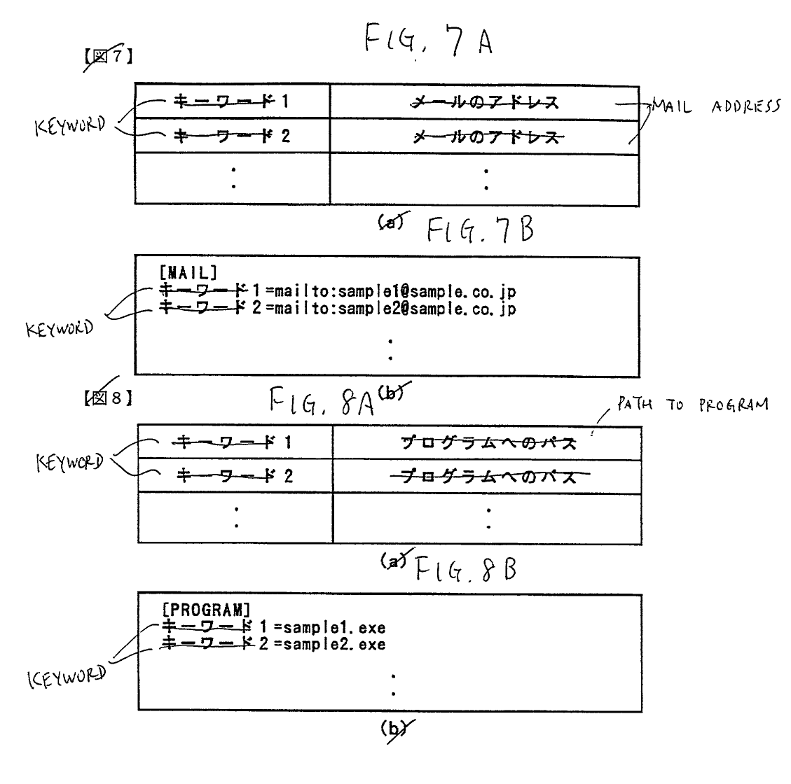

FIG. 2 is a system block diagram showing a hardware structure of the computer 1. As shown in FIG. 2, the computer 1 includes a CPU 10, a ROM 11, a RAM 12, a hard disk drive (HDD) 13, a floppy disk drive (FDD) 14, a CD-ROM drive 15, a graphic board 16, a communication control unit 17 for the network, modem or the like, and interfaces (I/Fs) 18 and 19.

A display unit 20 is connected to the graphic board 16. A communication line is connected to the communication control unit 17. A keyboard 21 is connected to the interface 18, and a mouse 22 is connected to the interface 19.

A starting program is stored in the ROM 11, and this starting program is executed by the CPU 10 when a power of the computer 1 is turned ON. For example, an operating system (OS) stored in the HDD 13 and various drivers for the display and communication processes are loaded into the RAM 12 by this starting program, so as to put the computer 1 in a state capable of carrying out various processes and control operations.

A program for controlling the computer 1 is developed in the RAM 12, and this RAM 12 is also used for holding temporary data and display data. The temporary data include processed results of the program and data which are to be processed by the program. The display data include data which are developed in the RAM 12 to be displayed on the display unit 20. The display data developed in the RAM 12 are displayed on a screen of the display unit 20 via the graphic board 16.

The HDD 13 and the FDD 14 are provided to record the programs, control data, and documents and image data which are created, in a hard disk and a floppy disk 23, respectively.

In this embodiment, a dictionary search application 32, various dictionaries, a browser, a mail software 38 and other programs which will be described later are also recorded in the hard disk.

The CD-ROM drive 15 is used to read data and programs recorded in a CD-ROM 24.

The communication control unit 17 is used to exchange data between the computer 1 and another apparatus via the communication line, and to download a program from another apparatus into the computer 1 via the communication line.

The keyboard 21 includes a plurality of character keys, arrow keys and the like, and is used to input various data to the computer 1. The mouse 22 is used to select an instruction and to specify an arbitrary position on the screen of the display unit 20 by a mouse cursor.

A character input program for causing the computer 1 having a character input function to carry out a process depending on the input characters according to an embodiment of a method according to the present invention is stored in a computer-readable storage medium according to the present invention which is formed by a recording medium such as the floppy disk 23 and the CD-ROM 24. This program is read from the floppy disk 23 by the FDD 14 or from the CD-ROM 24 by the CD-ROM drive 15, and is stored in the hard disk of the HDD 13. This program may be downloaded from another computer by the communication control unit 17 via the communication line, and stored in the hard disk of the HDD 13. This program stored in the hard disk of the HDD 13 is loaded into the RAM 12 in response to a predetermined instruction, so that various parts of the computer 1 are controlled to carry out the operation according to the present invention. The recording medium forming the computer-readable storage medium according to the present invention is of course not limited to disks, and may be realized by any type of recording medium, including optical and magneto-optical recording media and semiconductor memory devices, capable of storing the program.

In this specification, the character input function refers to the function of inputting characters, including alphanumeric characters, codes, symbols and the like. Further, a character string refers to a string made up of one or more characters.

In this embodiment, the computer 1 has a character input function for inputting Japanese Kana characters. When characters are input by the user from the keyboard 21 and one or more undefined characters in an undefined state, that is, an undefined character string, during a conversion process with respect to the characters, are displayed on the display unit 20, a bridge menu shown in FIG. 3 is displayed on the screen in response to a request from the user. As is well known in word processors having Japanese language processing functions, the conversion process converts one or more input Japanese Kana characters (Kana character string) into one or more Japanese Kanji characters or a combination of one or more Japanese Kanji characters and one or more Japanese Kana characters (Kanji character string). In addition, candidates formed by one or more undefined characters are successively displayed and one desired candidate is selected by the user and defined as one or more defined characters in a converted state.

In the particular case shown in FIG. 3, a combination of a Japanese Kanji character and a Japanese Kana character, namely, “ [symbol] ”, is the input character string in the undefined state. The bridge menu shown in FIG. 3 may be requested by the user by pressing a predetermined key of the keyboard 21 or making an instruction by operating a pointing device such as the mouse 22.

A stage at which the input character string is defined depends on the language and the like being processed. For example, in the case of the Japanese language processing in general, the input Kana character string is defined when a “non-conversion key” is pushed after the Kana character string is input. In addition, the input Kana character string is converted into a candidate Kanji character string when a “conversion key” is pushed after the Kana character string is input, and the input Kana character string is converted into another candidate Kanji character string when the “conversion key” is pushed again. The candidate Kanji character string is defined when a next character is input after the “conversion key” is pushed.

The bridge menu shown in FIG. 3 includes menu items related to dictionary searches, menu items related to starting programs, and menu items related to conversions. The menu items related to the dictionary searches include “look up Japanese dictionary”, “look up Japanese-English dictionary”, “look up English-Japanese dictionary”, “look up science and technical term dictionary”, and “look up modern (or present-day) language dictionary”. The menu items related to the starting programs include “internet search”, “open home page”, “send mail”, and “start program”. The menu items related to the conversions include “quick Japanese-English translation”, “quick synonym search”, “quick single Kanji translation”, “postal code conversion”, and “date conversion”.

FIG. 4 is a diagram showing an embodiment of the computer 1 according to the present invention.

As shown in FIG. 4, the computer 1 generally includes a Kana-Kanji converting section 30 for carrying out a conversion process to convert an input Kana character string into a Kanji character string, a dictionary information acquiring section 31 for carrying out an acquiring process to acquire information of installed dictionaries (not shown), a dictionary search application 32 for carrying out a search process to search for dictionary data indicated by specified characters with respect to a specified dictionary, a search site address definition file 33, a browser 34 for carrying out an inspection process to inspect a search page of a search site, a home page address definition file 35, a browser 36 for carrying out an inspection process to inspect a home page, a mail address definition file 37, a mail software 38 for carrying out sending and receiving processes to send and receive mail, a program path definition file 39, and one or a plurality of programs 40 which are to be started to carry out one or a plurality of prescribed processes. The browsers 34 and 36 may be realized by independent browsers or by a single common browser.

Of the menu items related to the conversions, the “quick Japanese-English translation” function is a conversion function for converting a specified word of the input character string into a corresponding English word, and displaying candidates of the corresponding English words if plural candidates exist. The “quick synonym search” function is a conversion function for converting a specified word of the input character string into a corresponding synonym, and displaying candidates of the corresponding synonyms if a plural candidates exist. The “quick single Kanji translation” function is a conversion function for converting a specified single Kanji character of the input character string into a meaning of this single Kanji character in Japanese, and displaying candidates of the meanings if plural candidates exist. The “postal code conversion” function is a conversion function for converting a specified postal code of the input character string into corresponding address information, and displaying the corresponding address information. Further, the “date conversion” function is a conversion function for acquiring and displaying today's date or the present time in response to one or more specified characters of the input character string. These conversion functions selectable from the menu items related to the conversions are realized by the Kana-Kanji converting section 30.

The Kana-Kanji converting section 30 operates in the same manner as a conventional Kana-Kanji converting section in that the processes of defining the input character string and displaying candidates of the converted character string are carried out in response to operations of the “non-conversion key” and the “conversion key”.

The functions of the computer 1 described above are realized by the program which is stored in the computer-readable storage medium according to the present invention. As described above, the recording medium forming the computer-readable storage medium according to the present invention is not limited to a specific type of recording medium.

FIGS. 5A and 5B respectively are diagrams for explaining a file structure of the search site address definition file 33. FIGS. 6A and 6B respectively are diagrams for explaining a file structure of the home page address definition file 35. FIGS. 7A and 7B respectively are diagrams for explaining a file structure of the mail address definition file 37. In addition, FIGS. 8A and 8B respectively are diagrams for explaining a file structure of the program path definition file 39.

As shown in FIGS. 5A and 5B, the search site address definition file 33 manages names of specified search sites, and defines corresponding relationships of names of each of the search sites connected to the network 3 and URLs thereof. FIG. 5A shows a basic data structure of the search site address definition file 33, and FIG. 5B shows particular examples of the data of the search site address definition file 33.

As shown in FIGS. 6A and 6B, the home page address definition file 35 defines corresponding relationships of keywords and URLs of home pages allocated to the keywords. For example, the home page address definition file 35 defines corresponding relationship data to indicate that the URL of the home page of “Fujisan Corporation” is allocated to the keyword “Fujisan”. FIG. 6A shows a basic data structure of the home page address definition file 35, and FIG. 6B shows particular examples of the data of the home page address definition file 35.

As shown in FIGS. 7A and 7B, the mail address definition file 37 defines corresponding relationships of keywords and mail addresses allocated to the keywords. For example, the mail address definition file 37 defines the corresponding relationship data to indicate that the mail address of “Taro Fujisan” is allocated to the keyword “Taro Fujisan”. FIG. 7A shows a basic data structure of the mail address definition file 37, and FIG. 7B shows particular examples of the data of the mail address definition file 37.

As shown in FIGS. 8A and 8B, the program path definition file 39 defines corresponding relationships of keywords and path information to programs allocated to the keywords. The path information to a program refers to information of a file to be executed in order to start the program. For example, the program path definition file 39 defines corresponding relationship data to indicate that the path information to a calculation program having a calculator function is allocated to the keyword “calculator”. FIG. 8A shows a basic data structure of the program path definition file 39, and FIG. 8B shows particular examples of the data of the program path definition file 39.

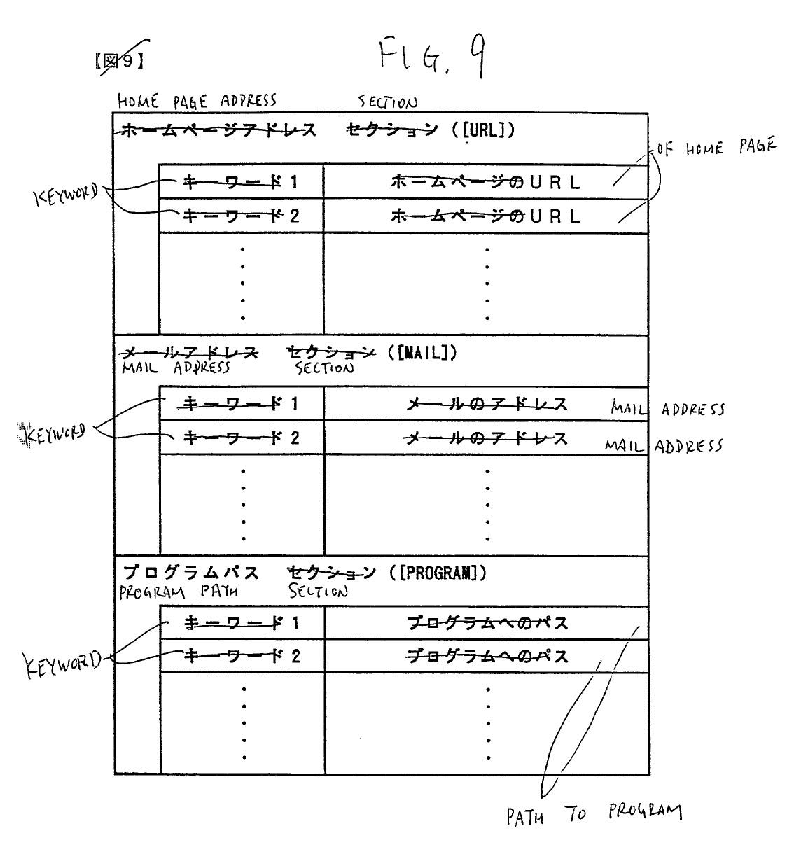

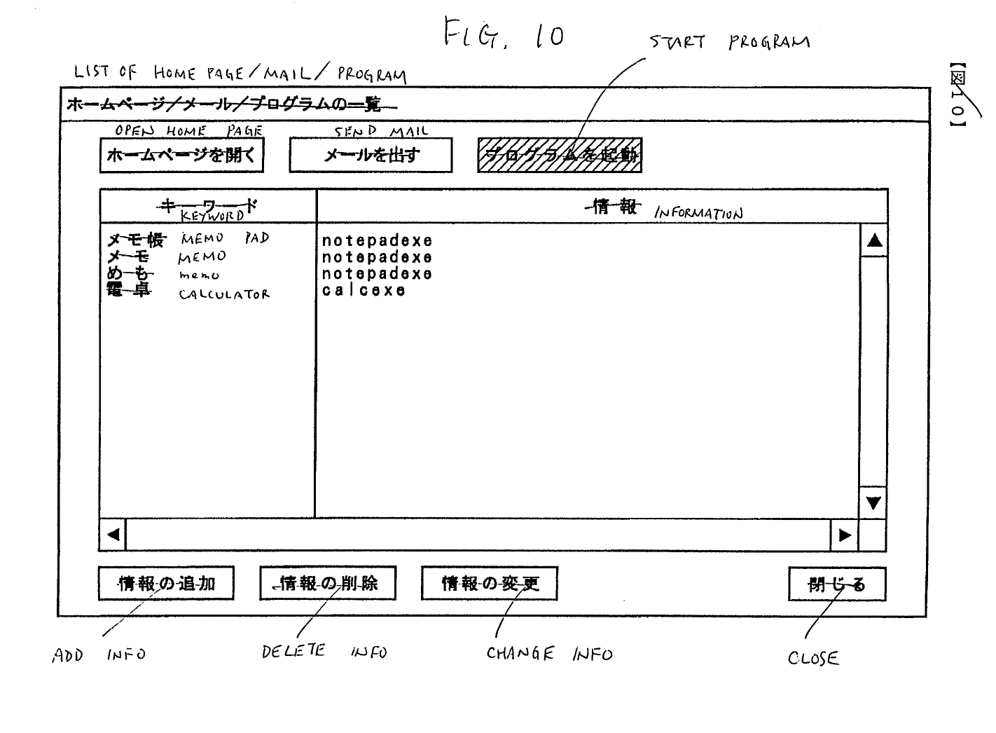

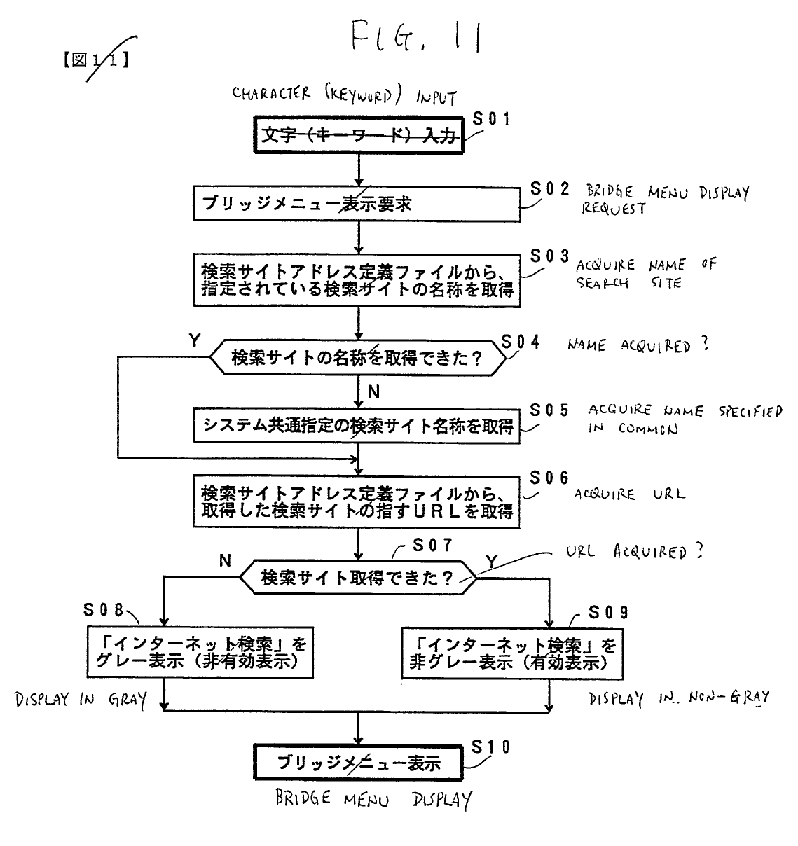

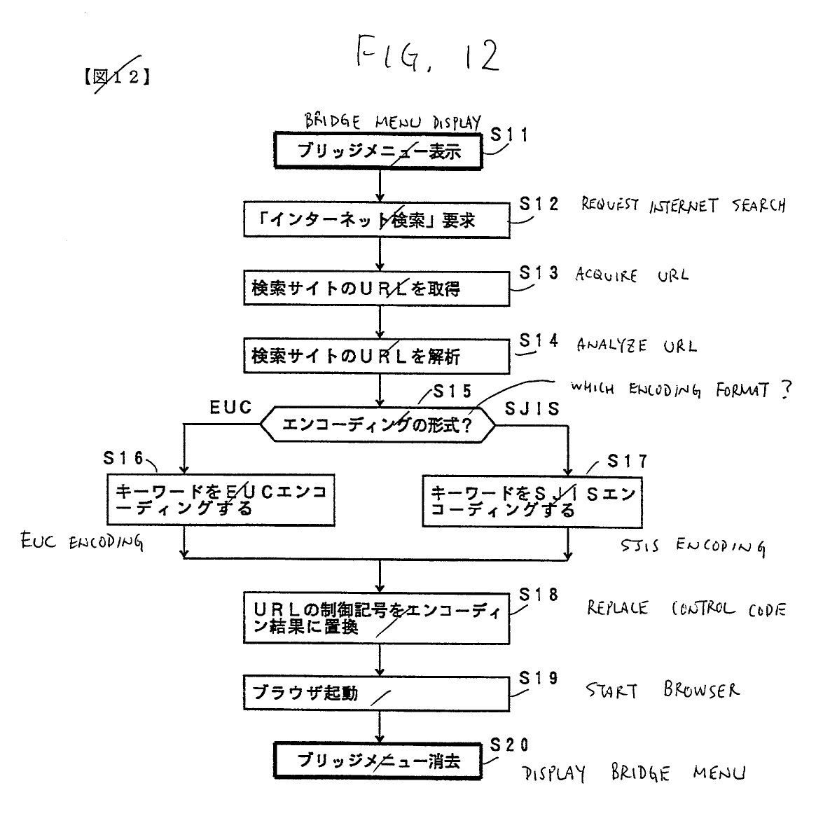

FIG. 9 is a diagram for explaining a common file structure. The home page address definition file 35, the mail address definition file 37 and the program path definition file 39 have the same file structure. Accordingly, these definition files 35, 37 and 39 may be provided within a single file having the common file structure shown in FIG. 9.

FIG. 10 is a diagram for explaining an interactive screen. The file data of the home page address definition file 35, the file data of the mail address definition file 37, and the file data of the program path definition file 39 may be set by use of the interactive screen shown in FIG. 10, as one set mode for setting the environment.

In the interactive screen shown in FIG. 10, it is possible to make a setting corresponding to each of the selectable items “open home page”, “send mail” and “start program” on the bridge menu screen.

Buttons for switching the selected item for making the setting are displayed in an upper portion of the interactive screen. Contents of the corresponding definition file, that is, the keyword and the corresponding information, are displayed depending on the selected button, so that an editing operation can be made with respect to the definition file.

On the other hand, buttons for instructing the kind of editing operation are displayed in a lower portion of the interactive screen. In the particular case shown in FIG. 10, three buttons “add information”, “delete information” and “change information” are provided for instructing the kinds of editing operation. The “add information” button is selected when newly registering a corresponding relationship of a keyword and information, the “delete information” button is selected when deleting a registered corresponding relationship of the keyword and the information, and the “change information” button is selected when changing a registered corresponding relationship of the keyword and the information.

More particularly, an input screen is displayed when the “add information” button is selected, and new corresponding information can be written into the definition file by inputting a corresponding relationship of a desired keyword and information. In addition, when the corresponding relationship of the displayed keyword and information is selected and the “delete information” button is selected, it is possible to delete the selected corresponding relationship from the definition file. Furthermore, when the corresponding relationship of the displayed keyword and information is selected and the “change information” button is selected, an input screen for changing the contents of the corresponding information is displayed, and the corresponding information written in the definition file can be changed by making appropriate inputs from this input screen.

By providing this setting function using the interactive screen, the user can freely register desired file data in the home page address definition file 35, the mail address definition file 37 and the program path definition file 39.

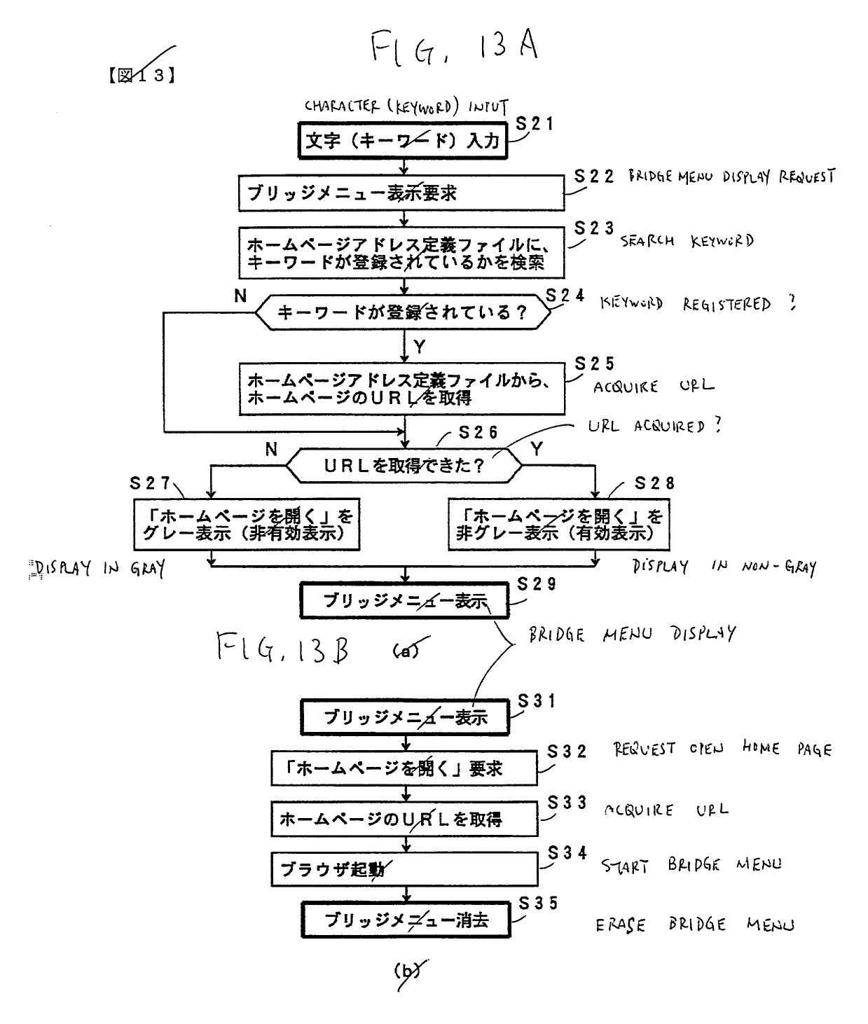

Next, a description will be given of the processes carried out by the Kana-Kanji converting section 30, by referring to FIGS. 11 through 20.

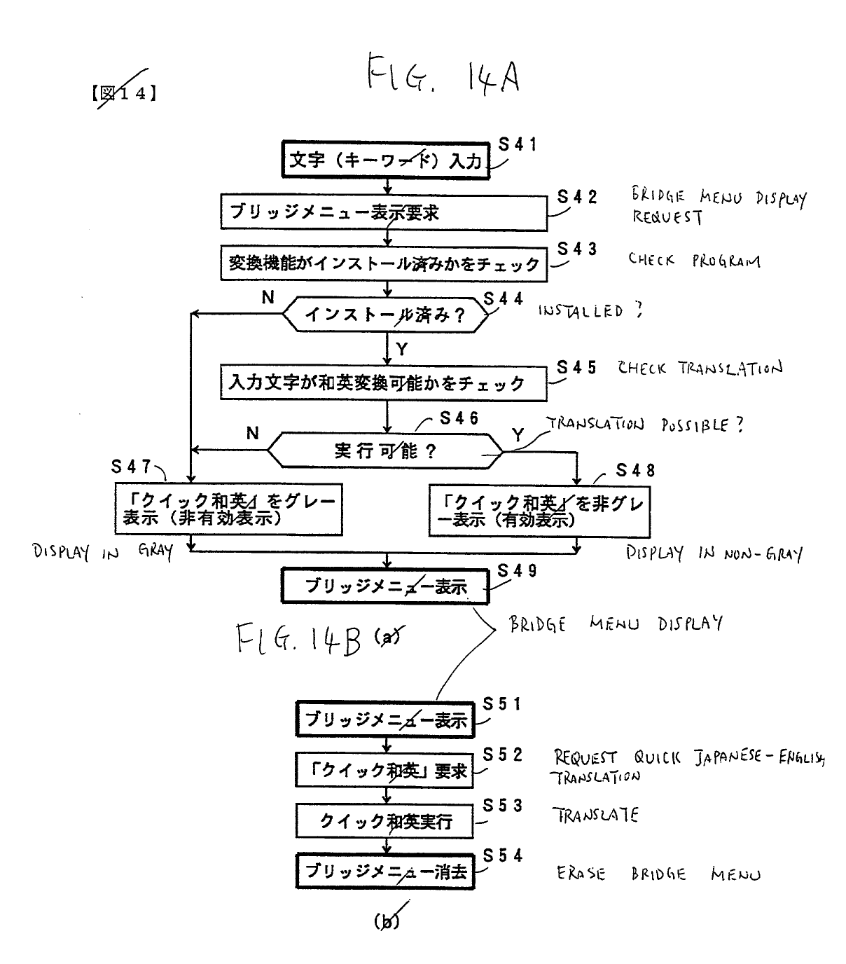

First, a description will be given of an internet search process which is carried out when the menu item “internet search” is selected on the bridge menu screen, by referring to FIGS. 11 and 12. FIGS. 11 and 12 are flow charts for explaining the internet search process carried out by the Kana-Kanji converting section 30.

In the Kana-Kanji converting section 30, as shown in FIG. 11, a step S01 inputs an undefined character string, which becomes the keyword, and is input by a key operation of the user from the keyboard 21. A step S02 inputs a bridge menu display request which is made by a key operation. In addition, a step S03 attempts to acquire a name of a search site which is specified in advance by the user, from the search site address definition file 33. A step S04 decides whether or not the attempt to acquire the name of the search site was successful. If the decision result in the step S04 is NO, a step S05 acquires a name of a search site which is specified in common for the system, and the process advances to a step S06. On the other hand, the process advances to the step S06 if the decision result in the step S04 is YES.

The step S06 refers to the search site address definition file 33 using the acquired name of the search site as a key, so as to attempt to acquire a URL of the acquired search site from the search site address definition file 33. A step S07 decides whether or not the attempt to acquire the URL of the search site was successful.

If the decision result in the step S07 is NO, a step S08 displays the menu item “internet search” on the bridge menu screen by a gray display to indicate an invalid state. On the other hand, if the decision result in the step S07 is YES, a step S09 displays the menu item “internet search” on the bridge menu screen by a non-gray display to indicate a valid state. After the step S08 or S09, a step S10 displays the bridge menu screen with the gray or non-gray display.

Accordingly, the Kana-Kanji converting section 30 refers to the search site address definition file 33 when the bridge menu display request is issued after the user inputs the undefined character string, and decides whether or not it is possible to acquire the search site for enabling the internet search. If the search site can be acquired, the menu item “internet search” on the bridge menu screen is displayed in the valid state.

Other processes which will be described later determine whether or not other menu items on the bridge menu screen are to be displayed in the valid state.

On the other hand, in the Kana-Kanji converting section 30, as shown in FIG. 12, if a step S11 displays the bridge menu screen with the menu item “internet search” displayed in the valid state, and a step S12 inputs a request for selecting the menu item “internet search”, a step S13 acquires the URL of the search site which is acquired by the process shown in FIG. 11.

Then, a step S14 analyzes the acquired URL of the search site. In other words, since the URL of the search site includes a control code prescribing an encoding format of the search keyword, the step S14 analyzes the encoding format prescribed by the control code. In this embodiment, it is assumed for the sake of convenience that the control code prescribes one of an EUC encoding format and a SJIS encoding format.

A step S15 decides whether the control code is prescribing the EUC encoding format or the SJIS encoding format. In a case where the URL shown in FIG. 5B includes “%EUC” and the control code prescribes the EUC encoding format, a step S16 encodes the keyword, that is, the undefined character string, input by the process shown in FIG. 11, according to the EUC encoding. On the other hand, in a case where the URL shown in FIG. 5B includes “%SJIS” and the control code prescribes the SJIS encoding format, a step S17 encodes the keyword, that is, the undefined character string, input by the process shown in FIG. 11, according to the SJIS encoding.

If the keyword includes a half-size Japanese Katakana character when carrying out the encoding in the step S16 or S17, a conversion process is carried out to convert the half-size character into a full-size character, depending on the request with respect to the search keyword of the search site.

A step S18 replaces the control code which is added to the acquired URL of the search site by an encoded result of the control code, so as to generate the URL for starting the search site, as shown in FIG. 21A. FIGS. 21A and 21B respectively are diagrams for explaining a method of converting the URL of the search site. Accordingly, when the input undefined character string “ [symbol] ” (“sample” in Japanese) in Katakana characters is used as the search keyword and the search request is issued with respect to the search site as shown in FIG. 21B, this keyword “ [symbol] ” is subjected to the EUC encoding and replaced by the control code, so as to generate the URL for starting the search site.

Next, a step S19 notifies the generated URL and instructs the operating system to start the browser 34. As a result, the browser 34 for carrying out the inspection process to inspect the search page of the search site is started. A step S20 then erases the bridge menu screen, and the process ends.

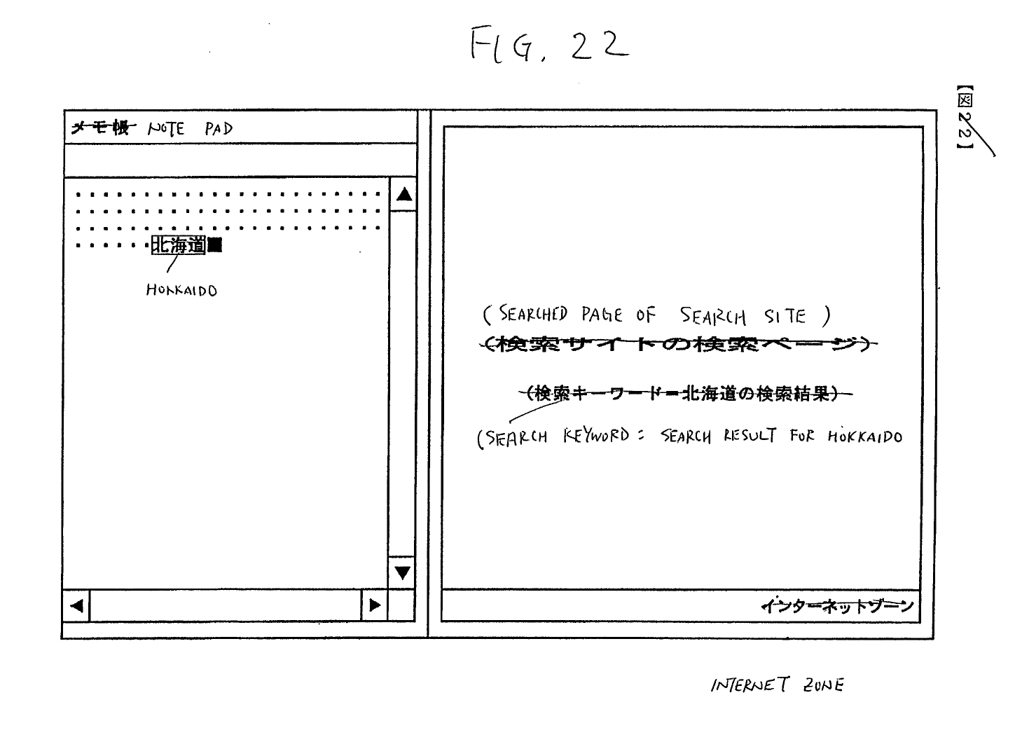

Therefore, when the menu item “internet search” on the bridge menu screen is selected, the Kana-Kanji converting section 30 uses the URL registered in the search site address definition file 33, and specifies the input undefined character string as the search keyword while issuing the search request with respect to the search site. Hence, search information related to the undefined character string and obtained from the search site is displayed on the display screen, as shown in FIG. 22. FIG. 22 is a diagram for explaining the screen displaying the search information related to the undefined character string and obtained from the search site. Hence, the user can easily and simply acquire information related to the character string by use of the internet search, while inputting the character string.

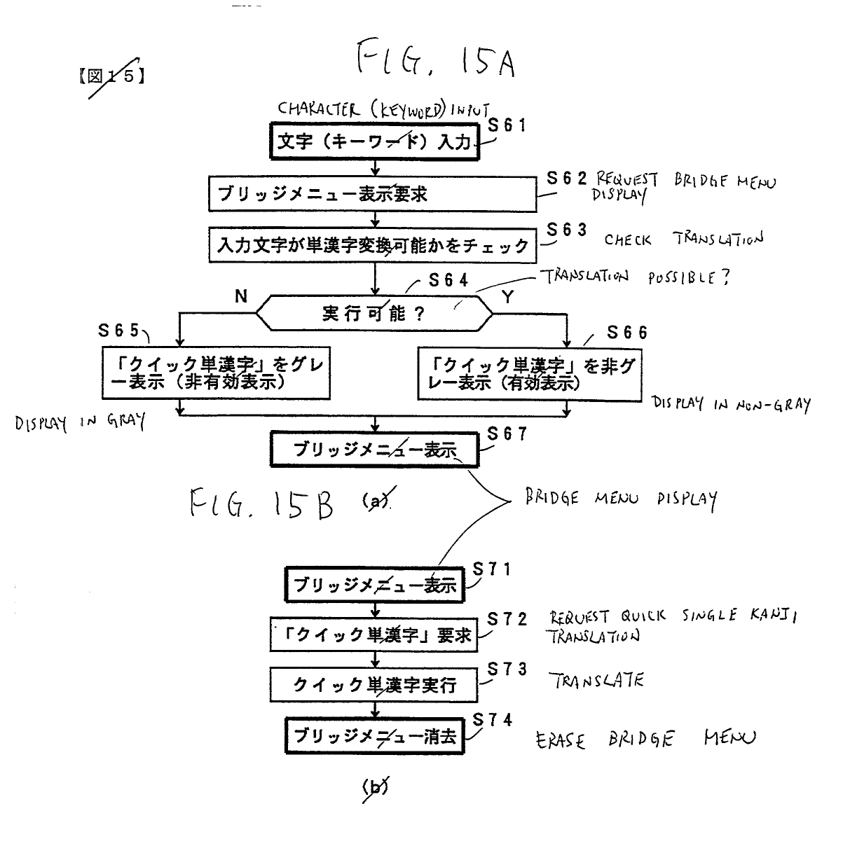

Next, a description will be given of a home page inspection process which is carried out when the menu item “open home page” is selected on the bridge menu screen, by referring to FIGS. 13A and 13B. FIGS. 13A and 13B respectively are flow charts for explaining the home page inspection process carried out by the Kana-Kanji converting section 30.

In the Kana-Kanji converting section 30, as shown in FIG. 13A, a step S21 inputs an undefined character string, which becomes the keyword, and is input by a key operation of the user from the keyboard 21. A step S22 inputs a bridge menu display request which is made by a key operation. In addition, a step S23 searches for the keyword, that is, the undefined character string, registered in the home page address definition file 35. A step S24 decides whether or not the keyword is registered in the home page address definition file 35.

If the decision result in the step S24 is YES, a step S25 acquires a URL of the home page corresponding to the keyword, from the home page address definition file 35, and the process advances to a step S26. On the other hand, if the decision result in the step S24 is NO, the process advances directly to the step S26 by omitting the step S25.

The step S26 decides whether or not the attempt to acquire the URL of the search site was successful. If the decision result in the step S26 is NO, a step S27 displays the menu item “open home page” on the bridge menu screen by a gray display to indicate an invalid state. On the other hand, if the decision result in the step S26 is YES, a step S28 displays the menu item “open home page” on the bridge menu screen by a non-gray display to indicate a valid state. After the step S27 or S28, a step S29 displays the bridge menu screen with the gray or non-gray display.

Accordingly, the Kana-Kanji converting section 30 refers to the home page address definition file 35 when the bridge menu display request is issued after the user inputs the undefined character string, and decides whether or not the home page corresponding to the undefined character string is registered in the home page address definition file 35. If the home page corresponding to the undefined character string is registered in the home page address definition file 35, the menu item “open home page” on the bridge menu screen is displayed in the valid state.

On the other hand, in the Kana-Kanji converting section 30, as shown in FIG. 13B, if a step S31 displays the bridge menu screen with the menu item “open home page” displayed in the valid state, and a step S32 inputs a request for selecting the menu item “open home page”, a step S33 acquires the URL of the search site which is acquired by the process shown in FIG. 13A.

Then, a step S34 notifies the generated URL and instructs the operating system to start the browser 36. As a result, the browser 36 for carrying out the inspection process to inspect the home page is started. A step S35 then erases the bridge menu screen, and the process ends.

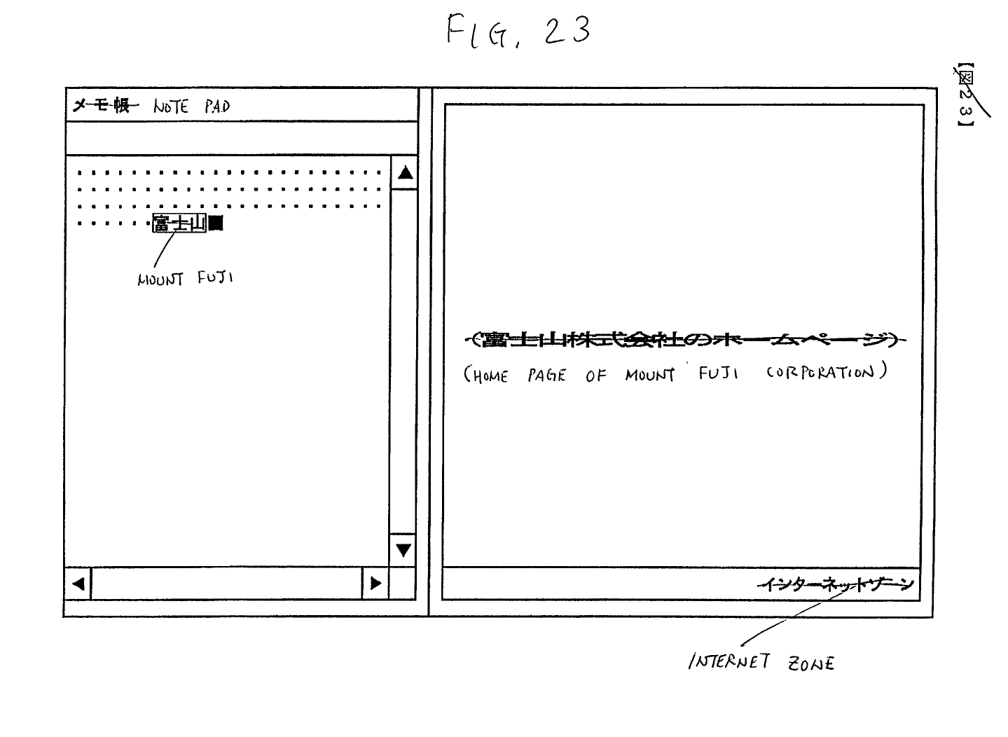

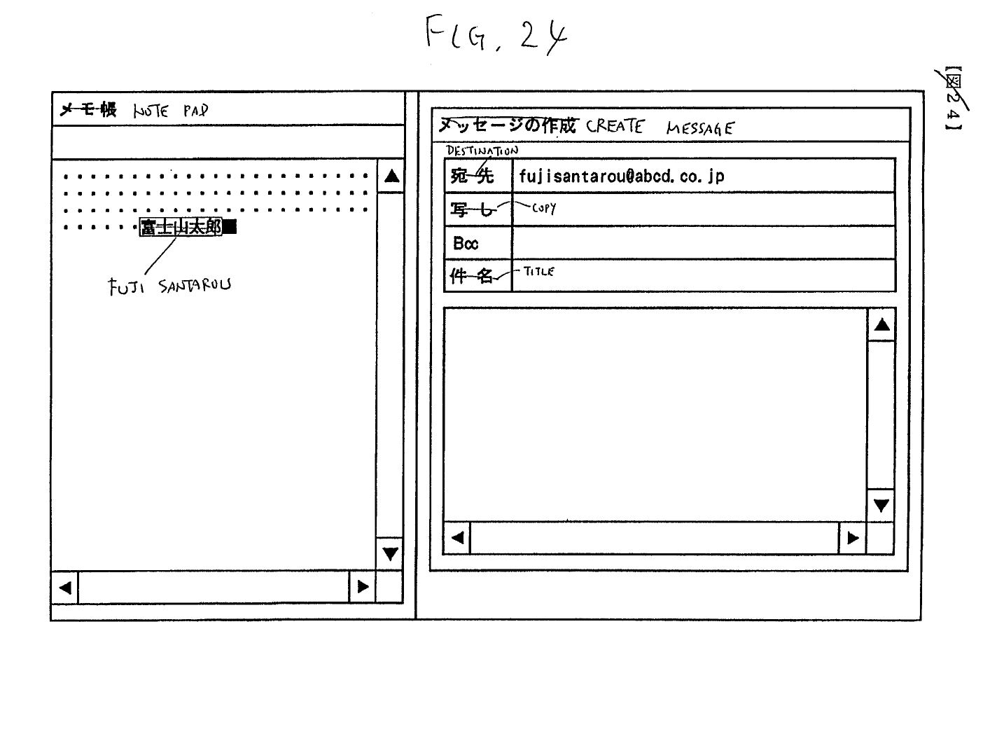

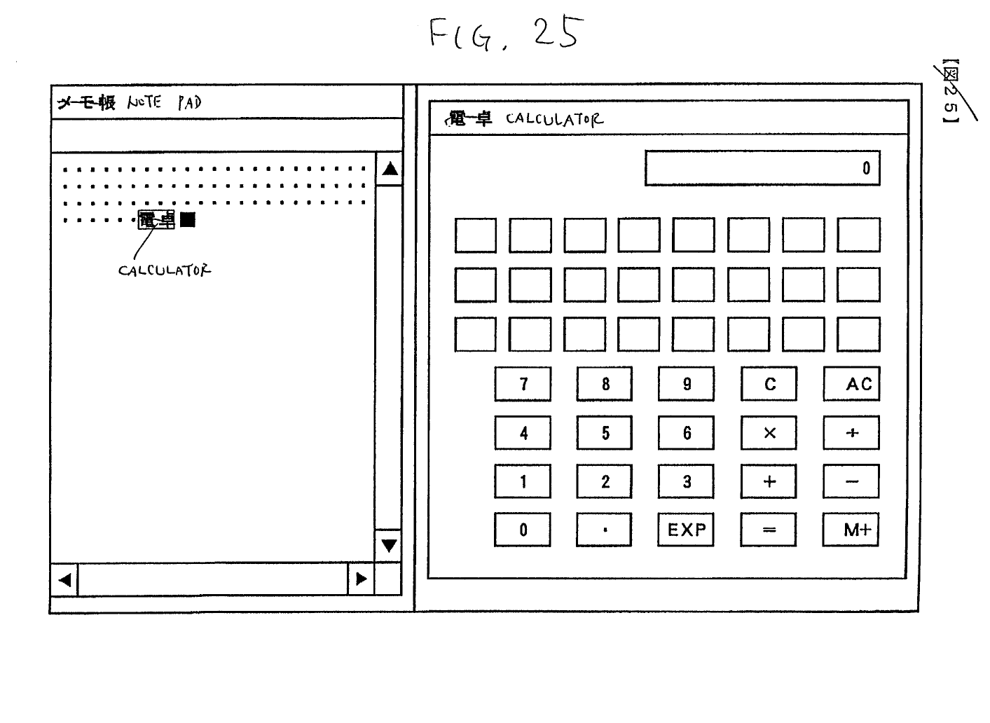

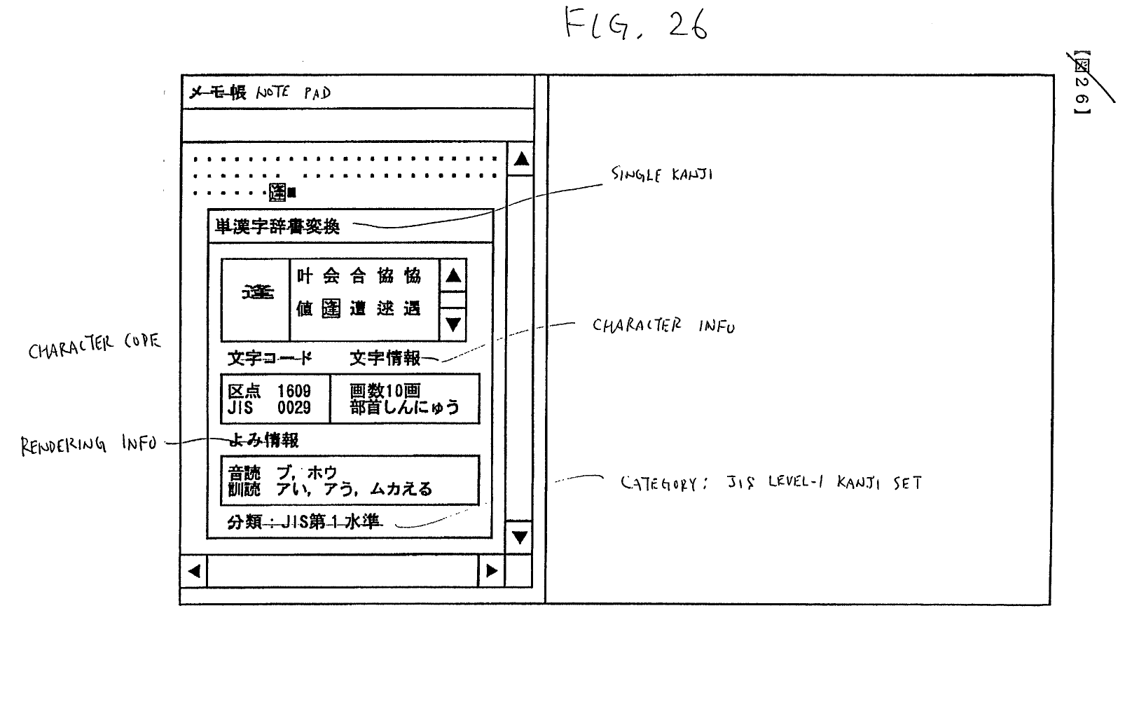

Therefore, when the menu item “open home page” on the bridge menu screen is selected, the Kana-Kanji converting section 30 uses the URL registered in the home page address definition file 35, and issues the inspection request with respect to the home corresponding to the input undefined character string. Hence, the home page corresponding to the undefined character string is displayed on the display screen, as shown in FIG. 23. FIG. 23 is a diagram for explaining the screen displaying the home page corresponding to the undefined character string. Hence, the user can easily and simply acquire the home page corresponding to the character string by use of the internet search, while inputting the character string.

Next, a description will be given of a mail sending process which is carried out when the menu item “send mail” is selected on the bridge menu screen. The mail sending process can be carried out similarly to the home page inspection process described above in conjunction with FIGS. 13A and 13B.

In other words, the Kana-Kanji converting section 30 inputs an undefined character string, that is, the keyword, which is input by a key operation of the user from the keyboard 21, and inputs a bridge menu display request which is made by a key operation. In addition, the Kana-Kanji converting section 30 decides whether or not a mail address corresponding to the keyword is registered in the mail address definition file 37. If the mail address corresponding to the keyword is registered in the mail address definition file 37, the menu item “send mail” on the bridge menu screen is displayed by a gray display to indicate a valid state.

Then, when the menu item “send mail” is selected on the bridge menu screen, the Kana-Kanji converting section 30 sets the mail address corresponding to the undefined character string and registered in the mail address definition file 37 as a destination mail address while starting the mail software 38. As a result, a mail sending screen which has the mail address corresponding to the undefined character string as the destination mail address is displayed on the display screen as shown in FIG. 24. FIG. 24 is a diagram for explaining the mail sending screen displaying the destination mail address corresponding to the undefined character string.

Therefore, the user can easily and simply send a mail to the mail address corresponding to the character string, while inputting the character string.

Next, a description will be given of a program starting process which is carried out when the menu item “start program” is selected on the bridge menu screen. The program starting process can be carried out similarly to the home page inspection process described above in conjunction with FIGS. 13A and 13B.

In other words, the Kana-Kanji converting section 30 inputs an undefined character string, that is, the keyword, which is input by a key operation of the user from the keyboard 21, and inputs a bridge menu display request which is made by a key operation. In addition, the Kana-Kanji converting section 30 decides whether or not program path information corresponding to the keyword is registered in the program path information definition file 39. If the program path information corresponding to the keyword is registered in the program path information definition file 39, the menu item “start program” on the bridge menu screen is displayed by a gray display to indicate a valid state.

Then, when the menu item “start program” is selected on the bridge menu screen, the Kana-Kanji converting section 30 starts a program corresponding to the undefined character string depending on the program path information registered in the program path information definition file 39. For example, the program corresponding to the undefined character string is a calculation program having a calculator function when the undefined character string is “calculator”, and the program corresponding to the undefined character string is a program having a memo creating function when the undefined character string is “memo”. As a result, an initial screen of the program is displayed on the display screen as shown in FIG. 25. FIG. 25 is a diagram for explaining a program processing screen for a case where the calculation program is started.

Therefore, the user can easily and simply start a program corresponding to the character string, while inputting the character string.

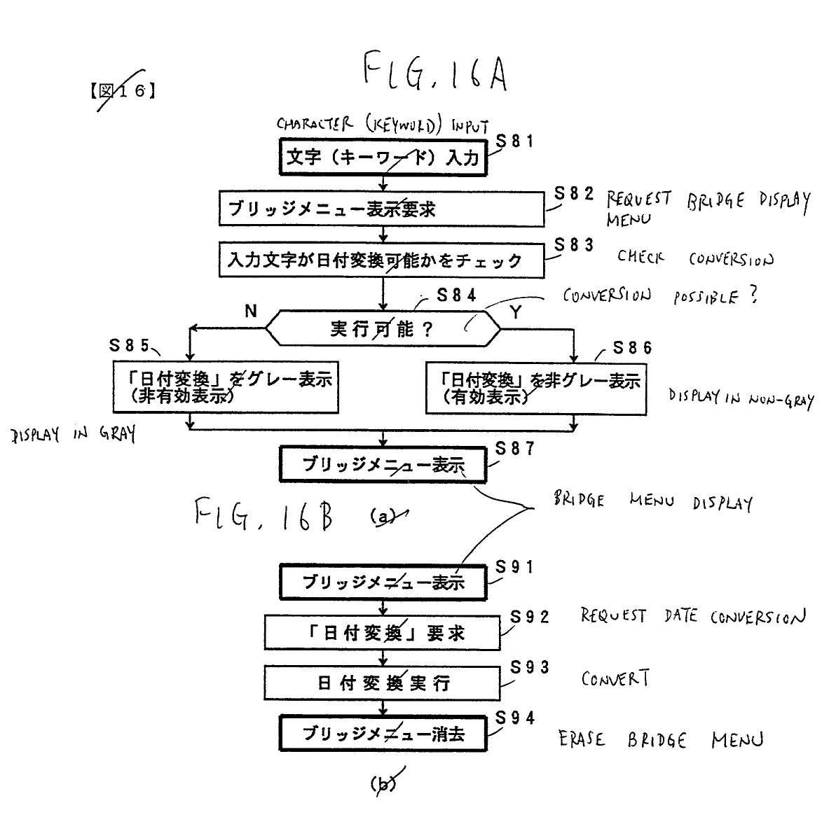

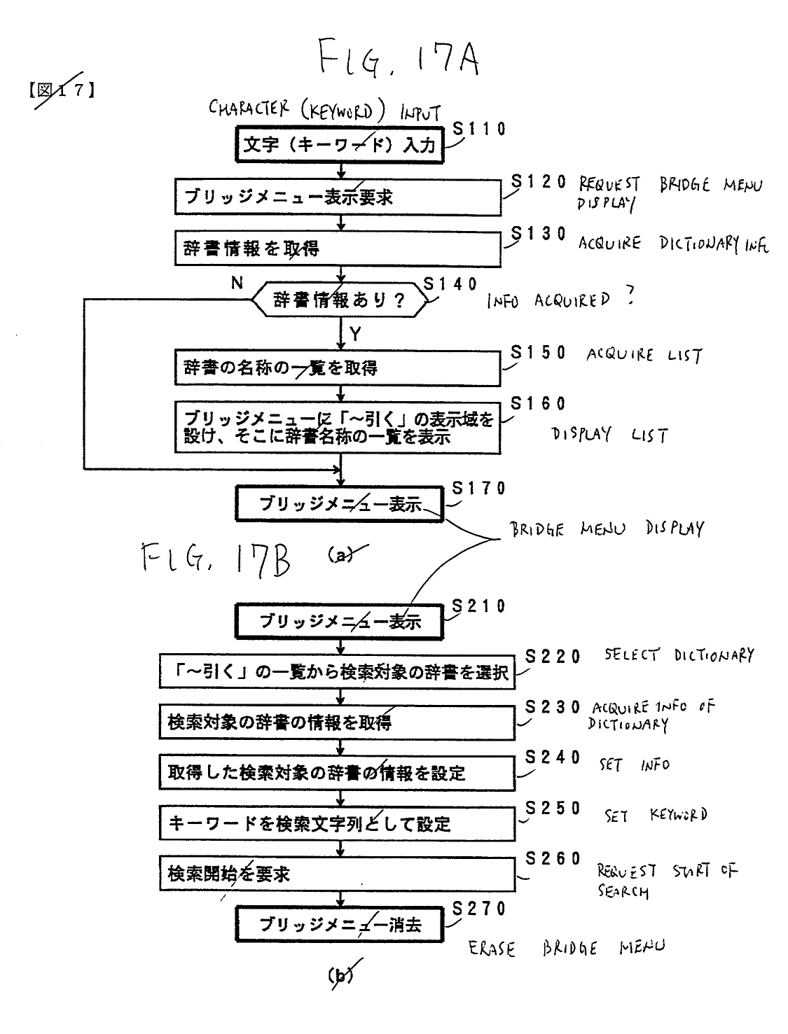

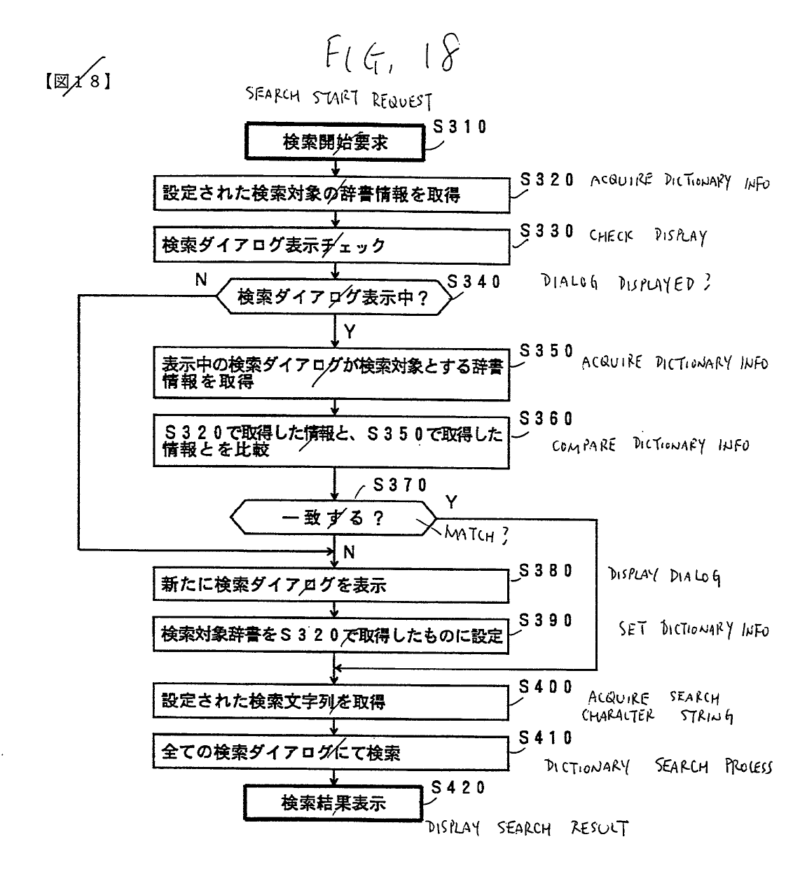

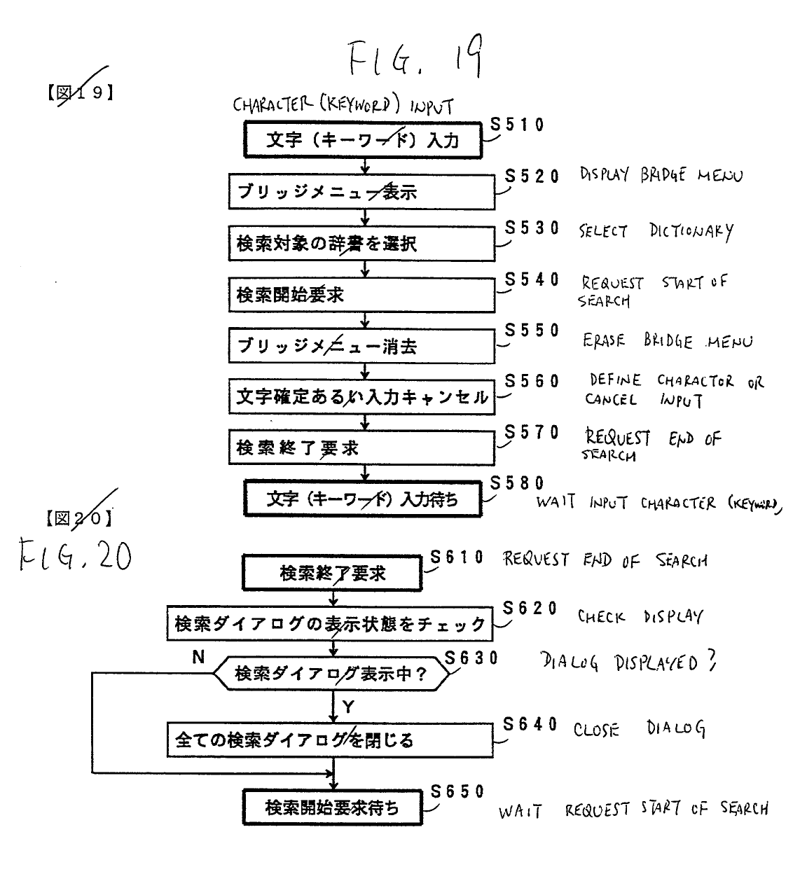

Next, a description will be given of a conversion process which is carried out when the menu item “quick Japanese-English translation” is selected on the bridge menu screen, by referring to FIGS. 14A and 14B. FIGS. 14A and 14B respectively are flow charts for explaining a quick Japanese-English translation process carried out by the Kana-Kanji converting section 30.

In the Kana-Kanji converting section 30, as shown in FIG. 14A, a step S41 inputs an undefined character string, which becomes the keyword, and is input by a key operation of the user from the keyboard 21. A step S42 inputs a bridge menu display request which is made by a key operation. In addition, a step S43 checks to determine whether a quick Japanese-English translation program is already installed in the computer 1. A step S44 decides whether or not the quick Japanese-English translation program installed in the computer 1.

If the decision result in the step S44 is YES, a step S45 checks to determine whether the input undefined character string can be subjected to the Japanese-English translation.

In other words, the quick Japanese-English translation program can carry out the Japanese-English translation only when the input character string is in a character state after a conversion process is carried out in response to the pushing of the “conversion key”. Hence, the step S45 checks to determine whether the input undefined character string is in this character state. In addition, when the input undefined character string is in the character state, the step S45 checks whether the undefined character string is registered in a Japanese-English dictionary which is omitted and not shown in FIG. 4, so as to check and determine whether the input undefined character string can be subjected to the Japanese-English translation.

Next, a step S46 decides whether or not the input undefined character string can be subjected to the Japanese-English translation. If the decision result in the step S46 is NO, a step S47 displays the menu item “quick Japanese-English translation” on the bridge menu screen by a gray display to indicate an invalid state. On the other hand, if the decision result in the step S46 is YES, a step S48 displays the menu item “quick Japanese-English translation” on the bridge menu screen by a non-gray display to indicate a valid state. After the step S47 or S48, a step S49 displays the bridge menu screen with the gray or non-gray display.

On the other hand, if the decision result in the step S44 is NO, the step S47 displays the menu item “quick Japanese-English translation” on the bridge menu screen by the gray display to indicate the invalid state, and the step S49 displays the bridge menu screen with the gray display.

Accordingly, the Kana-Kanji converting section 30 judges whether or not the input undefined character string can be subjected to the Japanese-English translation when the bridge menu display request is issued after the user inputs the undefined character string, and the menu item “quick Japanese-English translation” on the bridge menu screen is displayed in the valid state if the Japanese-English translation is possible.

On the other hand, in the Kana-Kanji converting section 30, as shown in FIG. 14B, if a step S51 displays the bridge menu screen with the menu item “quick Japanese-English translation” displayed in the valid state, and a step S52 inputs a request for selecting the menu item “quick Japanese-English translation”, a step S53 acquires English information corresponding to the input undefined character string by use of the quick Japanese-English translation program, and displays the acquired English information on the character input screen. Then, a step S54 erases the bridge menu screen, and the process ends.

Therefore, when the menu item “quick Japanese-English translation” on the bridge menu screen is selected, the Kana-Kanji converting section 30 uses the quick Japanese-English translation program to acquire the English information corresponding to the input undefined character string, and displays the English information on the display screen. Hence, the user can easily and simply acquire the English information corresponding to the character string by use of the quick Japanese-English translation program, while inputting the character string.

Next, a description will be given of a conversion process which is carried out when the menu item “quick synonym search” is selected on the bridge menu screen. The conversion process to convert the input undefined character string into a corresponding synonym can be carried out similarly to the quick Japanese-English translation process described above in conjunction with FIGS. 14A and 14B.

In other words, the Kana-Kanji converting section 30 inputs an undefined character string, that is, the keyword, which is input by a key operation of the user from the keyboard 21, and inputs a bridge menu display request which is made by a key operation. In addition, the Kana-Kanji converting section 30 decides whether or not the input undefined character string can be converted into a synonym. More particularly, it is determined that the conversion to the synonym is possible if a quick synonym conversion (or search) program for converting the input undefined character string into the synonym is already installed in the computer 1, the input undefined character string is in a prescribed character state, and a corresponding synonym is registered in a synonym dictionary. If the conversion to the synonym is possible, the menu item “quick synonym search” on the bridge menu screen is displayed by a gray display to indicate a valid state.

Then, when the menu item “quick synonym search” is selected on the bridge menu screen, the Kana-Kanji converting section 30 uses the quick synonym conversion program to acquire synonym information corresponding to the input undefined character string, and displays the acquired synonym information on the display screen. Therefore, the user can easily and simply acquire the synonym information corresponding to the character string by use of the quick synonym conversion program, while inputting the character string.

Next, a description will be given of a conversion process which is carried out when the menu item “postal code conversion” is selected on the bridge menu screen. The conversion process to convert a postal code indicated by the input undefined character string into a corresponding address can be carried out similarly to the quick Japanese-English translation process described above in conjunction with FIGS. 14A and 14B.

In other words, the Kana-Kanji converting section 30 inputs an undefined character string, that is, the keyword indicating the postal code, which is input by a key operation of the user from the keyboard 21, and inputs a bridge menu display request which is made by a key operation. In addition, the Kana-Kanji converting section 30 decides whether or not the input undefined character string can be converted into an address. More particularly, it is determined that the conversion to the address is possible if a postal code conversion program for converting the input undefined character string into the address is already installed in the computer 1, the input undefined character string is in a prescribed character state, and a corresponding address is registered in an address dictionary or directory. If the conversion to the address is possible, the menu item “postal code conversion” on the bridge menu screen is displayed by a gray display to indicate a valid state.

Then, when the menu item “postal code conversion” is selected on the bridge menu screen, the Kana-Kanji converting section 30 uses the postal code conversion program to acquire address information corresponding to the input undefined character string, and displays the acquired address information on the display screen. Therefore, the user can easily and simply acquire the address information corresponding to the postal code indicated by the character string by use of the postal code conversion program, while inputting the character string.

When the user confirms that the address information which is acquired and displayed in this manner is correct or acceptable, the user may replace the input undefined character string indicating the postal code by this address information.

Next, a description will be given of a conversion process which is carried out when the menu item “quick single Kanji translation” is selected on the bridge menu screen, by referring to FIGS. 15A and 15B. FIGS. 15A and 15B respectively are flow charts for explaining a quick single Kanji translation process carried out by the Kana-Kanji converting section 30.

In the Kana-Kanji converting section 30, as shown in FIG. 15A, a step S61 inputs an undefined character string, which becomes the keyword, and is input by a key operation of the user from the keyboard 21. A step S62 inputs a bridge menu display request which is made by a key operation. In addition, a step S63 checks to determine whether the keyword, that is, the single Kanji character of the undefined character string, can be subjected to a quick single Kanji translation by a quick single Kanji translation program.

The quick single Kanji translation program is always installed in the computer 1 if the computer 1 processes Japanese. Hence, the step S63 determines whether the input undefined character string can be subjected to the quick single Kanji translation, by checking whether or not the input undefined character string is in a character state which can be subjected to the single Kanji translation, and checking whether the input undefined character string is registered in a single Kanji translation dictionary which is omitted and not shown in FIG. 4.

Then, a step S64 decides whether or not the input undefined character string can be subjected to the quick single Kanji translation. If the decision result in the step S64 is NO, a step S65 displays the menu item “quick single Kanji translation” on the bridge menu screen by a gray display to indicate an invalid state. On the other hand, if the decision result in the step S64 is YES, a step S66 displays the menu item “quick single Kanji translation” on the bridge menu screen by a non-gray display to indicate a valid state. After the step S65 or S66, a step S67 displays the bridge menu screen with the gray or non-gray display.

Accordingly, the Kana-Kanji converting section 30 judges whether or not the input undefined character string can be subjected to the single Kanji translation when the bridge menu display request is issued after the user inputs the undefined character string, and the menu item “quick single Kanji translation” on the bridge menu screen is displayed in the valid state if the single Kanji translation is possible.

On the other hand, in the Kana-Kanji converting section 30, as shown in FIG. 15B, if a step S71 displays the bridge menu screen with the menu item “quick single Kanji translation” displayed in the valid state, and a step S72 inputs a request for selecting the menu item “quick single Kanji translation”, a step S73 acquires information corresponding to the input undefined character string by use of the quick single Kanji translation program, and displays the acquired information on the character input screen. Then, a step S74 erases the bridge menu screen, and the process ends.

Therefore, when the menu item “quick single Kanji translation” on the bridge menu screen is selected, the Kana-Kanji converting section 30 uses the quick single Kanji translation program to acquire the information corresponding to the single Kanji character of the input undefined character string, and displays the information on the display screen as shown in FIG. 26. Hence, the user can easily and simply acquire the information corresponding to the single Kanji character of the character string by use of the quick single Kanji translation program, while inputting the character string.

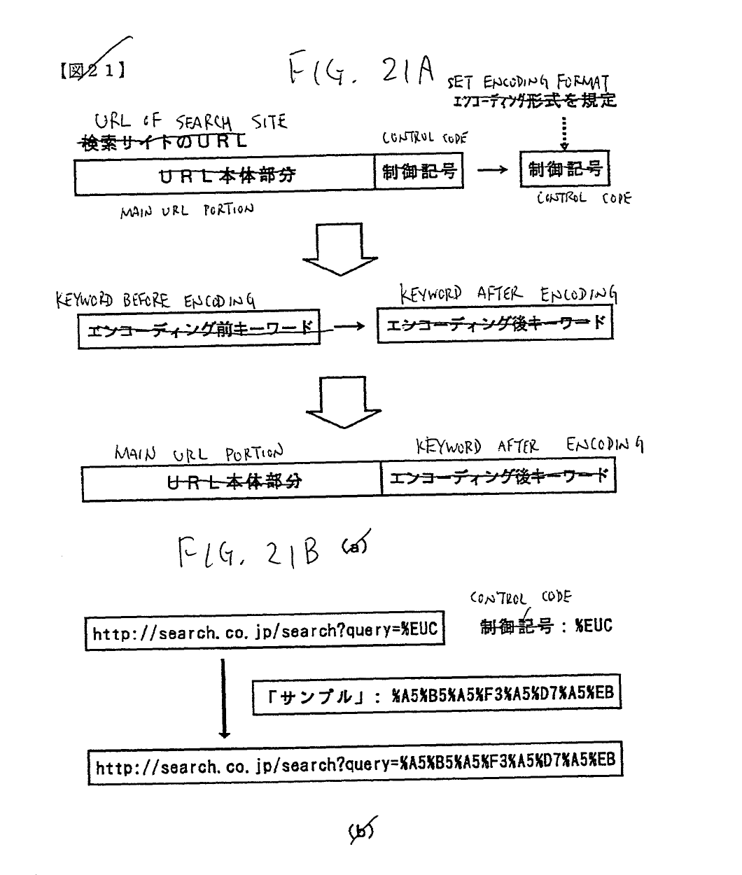

Next, a description will be given of a date conversion process which is carried out when the menu item “date conversion” is selected on the bridge menu screen, by referring to FIGS. 16A and 16B. FIGS. 16A and 16B respectively are flow charts for explaining a date conversion process carried out by the Kana-Kanji converting section 30.

In the Kana-Kanji converting section 30 , as shown in FIG. 16A, a step S81 inputs an undefined character string, which becomes the keyword, and is input by a key operation of the user from the keyboard 21. A step S82 inputs a bridge menu display request which is made by a key operation. In addition, a step S83 checks to determine whether the keyword, that is, the undefined character string, can be subjected to a date conversion by a date conversion program.

The date conversion program is always installed in the computer 1. Hence, the step S83 determines whether the input undefined character string can be subjected to the date conversion, by checking whether or not the input undefined character string is in a character state which can be subjected to the date conversion, such as in a character state before a conversion process is carried out. For example, the step S83 checks whether the input undefined character string is “ [symbol] ” (“date” in Kana characters), “ [symbol] ” (“time” in Kana characters) or the like.

Then, a step S84 decides whether or not the input undefined character string can be subjected to the date conversion. If the decision result in the step S84 is NO, a step S85 displays the menu item “date conversion” on the bridge menu screen by a gray display to indicate an invalid state. On the other hand, if the decision result in the step S84 is YES, a step S86 displays the menu item “date conversion” on the bridge menu screen by a non-gray display to indicate a valid state. After the step S85 or S86, a step S87 displays the bridge menu screen with the gray or non-gray display.

Accordingly, the Kana-Kanji converting section 30 judges whether or not the input undefined character string can be subjected to the date conversion when the bridge menu display request is issued after the user inputs the undefined character string, and the menu item “date conversion” on the bridge menu screen is displayed in the valid state if the date conversion is possible.

On the other hand, in the Kana-Kanji converting section 30, as shown in FIG. 16B, if a step S91 displays the bridge menu screen with the menu item “date conversion” displayed in the valid state, and a step S92 inputs a request for selecting the menu item “date conversion”, a step S93 acquires date information corresponding to the input undefined character string by use of the date conversion program, and displays the acquired date information on the character input screen. For example, the date information indicates today's date when the input undefined character string is “ [symbol] ” (“date” in Kana characters), and indicates the present time when the input undefined character string is “ [symbol] ” (“time” in Kana characters). Then, a step S94 erases the bridge menu screen, and the process ends.

As is well known, the date information related to today's date, the present time and the like may be acquired from an internal clock of the computer 1.

Therefore, when the menu item “date conversion” on the bridge menu screen is selected, the Kana-Kanji converting section 30 uses the date conversion program to acquire the date information corresponding to the input undefined character string, and displays the date information on the display screen. Hence, the user can easily and simply acquire the date information corresponding to the character string by use of the date conversion program, while inputting the character string.

When the user confirms that the date information which is acquired and displayed in this manner is correct or acceptable, the user may replace the input undefined character string by this date information.

Next, a description will be given of a dictionary search process which is carried out when the menu item related to the dictionary search is selected on the bridge menu screen, by referring to FIGS. 17A, 17B and FIGS. 18 through 20.

In the Kana-Kanji converting section 30, as shown in FIG. 17A, a step S110 inputs an undefined character string, which becomes the keyword, and is input by a key operation of the user from the keyboard 21. A step S120 inputs a bridge menu display request which is made by a key operation. In addition, a step S130 requests the dictionary information acquiring section 31 shown in FIG. 4 to acquire information of the installed dictionaries.

A step S140 decides whether or not the information of the installed dictionaries was acquired. If the decision result in the step S140 is YES, a step S150 acquires a list of names of the installed dictionaries. Then, a step S160 provides a display region “look up . . . ” on the bridge menu screen, and displays the list of the acquired dictionary names in this display region. As a result, a step S170 displays the bridge menu screen with the list of the acquired dictionary names.

Accordingly, when the user makes a display request after inputting the undefined character string, the Kana-Kanji converting section 30 displays the bridge menu screen with the menu items related to the dictionary searches, including “look up Japanese dictionary”, “look up Japanese-English dictionary”, “look up English-Japanese dictionary”, “look up science and technical term dictionary”, and “look up modern (or present-day) language dictionary” as shown in FIG. 3.

On the other hand, if the decision result in the step S140 is NO, the process advances to the step S170 to simply display the bridge menu screen.

In addition, in the Kana-Kanji converting section 30, when a step S210 displays the bridge menu display with a valid display of the list of “look up . . . ” and a next step S220 detects a selection of a target dictionary from the list of “look up . . . ” by the mouse 22 as shown in FIG. 17B, a step S230 acquires the information of the selected target dictionary from the information of the dictionaries acquired in the process shown in FIG. 17A.

Then, a step S240 sets the acquired information of the target dictionary as a processing target, and a step S250 sets the input undefined character string (keyword) as a searching character string. A step S260 instructs a start of the search with respect to the dictionary search application 32 while notifying the set information. A step S270 erases the bridge menu screen, and the process ends.

Therefore, when the dictionary included in the list of “look up . . . ” on the bridge menu screen is selected as the target dictionary, the Kana-Kanji converting section 30 sets the selected dictionary as the search target, and instructs the dictionary search application 32 to search for dictionary data indicated by the input undefined character string in the target dictionary.

In response to this search instruction to search for the dictionary data, the dictionary search application 32 carries out a process shown in FIG. 18. A step S310 receives the search instruction from the Kana-Kanji converting section 30, and a step S320 acquires the dictionary information which is set as the processing target by the Kana-Kanji converting section 30. A step S330 checks to determine whether a search dialog is being displayed in correspondence with the search target dictionary.

A step S340 decides whether or not the search dialog is being displayed. If the decision result in the step S340 is YES, a step S350 acquires the dictionary information of the search target indicated by the search dialog which is being displayed. In addition, a step S360 compares the dictionary information acquired in the step S320 and the dictionary information acquired in the step S350.

A step S370 decides whether or not the two compared dictionary information match. If the decision result in the step S370 is NO, it is judged that the search target of the search request is a new dictionary, and the process advances to a step S380. The step S380 displays a new search dialog corresponding to the new dictionary information, and a step S390 sets the dictionary information acquired in the step S320 as the search target dictionary which is treated in the newly displayed search dialog. The process advances to a step S400 after the step S390.

On the other hand, if the decision result in the step S340 is NO, the process advances directly to the step S380. In this case, the step S380 displays a new search dialog corresponding to the dictionary information acquired in the step S320, and the step S390 sets the dictionary information acquired in the step S320 as the search target dictionary which is treated in the newly displayed search dialog. The process advances to a step S400 after the step S390.

If the decision result in the step S370 is YES, the steps S380 and S390 are omitted, and the process advances to the step S400.

The step S400 acquires the search character string which is set by the Kana-Kanji converting section 30, and a step S410 carries out a dictionary search process with each search dialog which is being displayed. A step S420 displays a search result on the display screen, and the process ends.

The Kana-Kanji converting section 30 carries out a process shown in FIG. 19 in response to the above described dictionary search process carried out by the dictionary search application 32. A step S510 inputs an undefined character string, which becomes the keyword, and is input by a key operation of the user from the keyboard 21. A step S520 inputs a bridge menu display request which is made by a key operation. In addition, a step S530 selects the search target dictionary, and a step S540 requests, with respect to the dictionary search application 32, the start of the search for the dictionary data corresponding to the input undefined character string in the search target dictionary. A step S550 erases the bridge menu screen, and a step S560 defines the input undefined character string or cancels the input, in response to an input operation such as a key operation made by the user. A step S570 requests the end of the search with respect to the dictionary search application 32, and a step S580 enters a character string (keyword) input waiting state which waits for the input of the next character string (keyword).

In response to the search end instruction from the Kana-Kanji converting section 30, the dictionary search application 32 carries out a process shown in FIG. 20. In other words, a step S610 receives the search end instruction from the Kana-Kanji converting section 30, and a step S620 checks the display state of the search dialog. A step S630 decides whether or not the search dialog is being displayed. If the decision result in the step S630 is YES, a step S640 closes each search dialog, and a step S650 enters a waiting state which waits for a next search start request. On the other hand, the process advances directly to the step S650 if the decision result in the step S630 is NO.

Therefore, when the dictionary included in the list of “look up . . . ” on the bridge menu screen is selected as the search target, the Kana-Kanji converting section 30 instructs the dictionary search application 32 to search the dictionary data indicated by the input undefined character string in the search target dictionary which is selected, and the acquired dictionary data is displayed on the display screen.

In addition, when defining or cancelling the input undefined character string in response to the input operation made by the user, the Kana-Kanji converting section 30 ends the dictionary search process of the dictionary search application 32 in synchronism with the defining or cancelling of the input undefined character string.

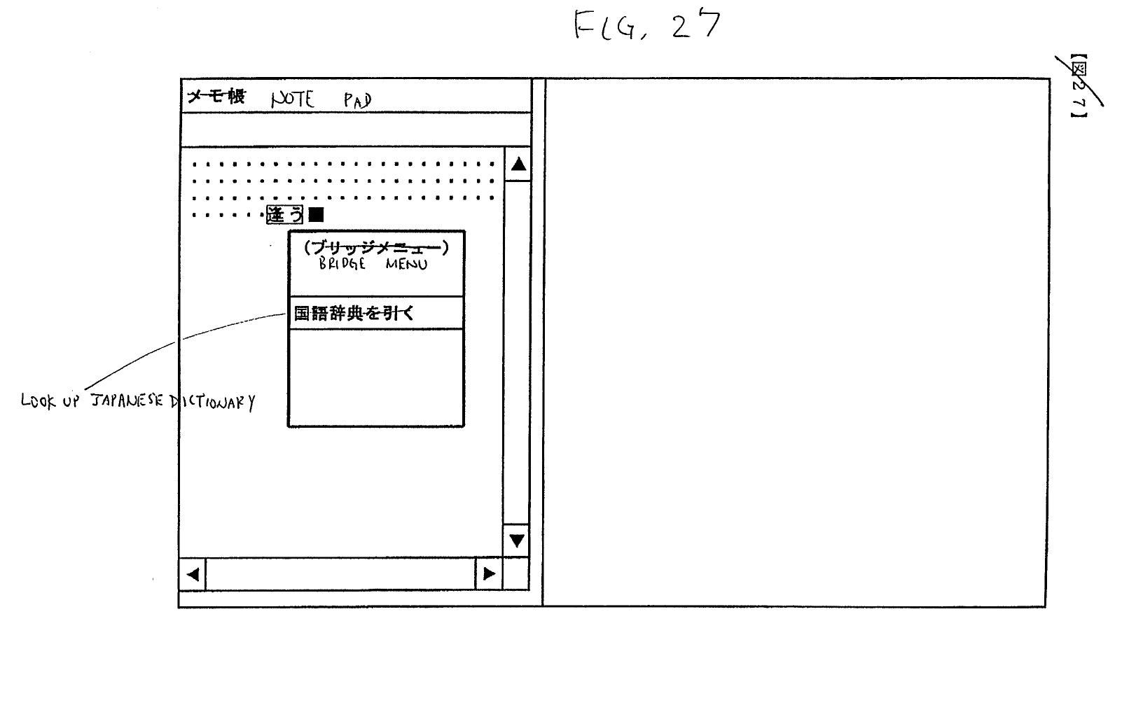

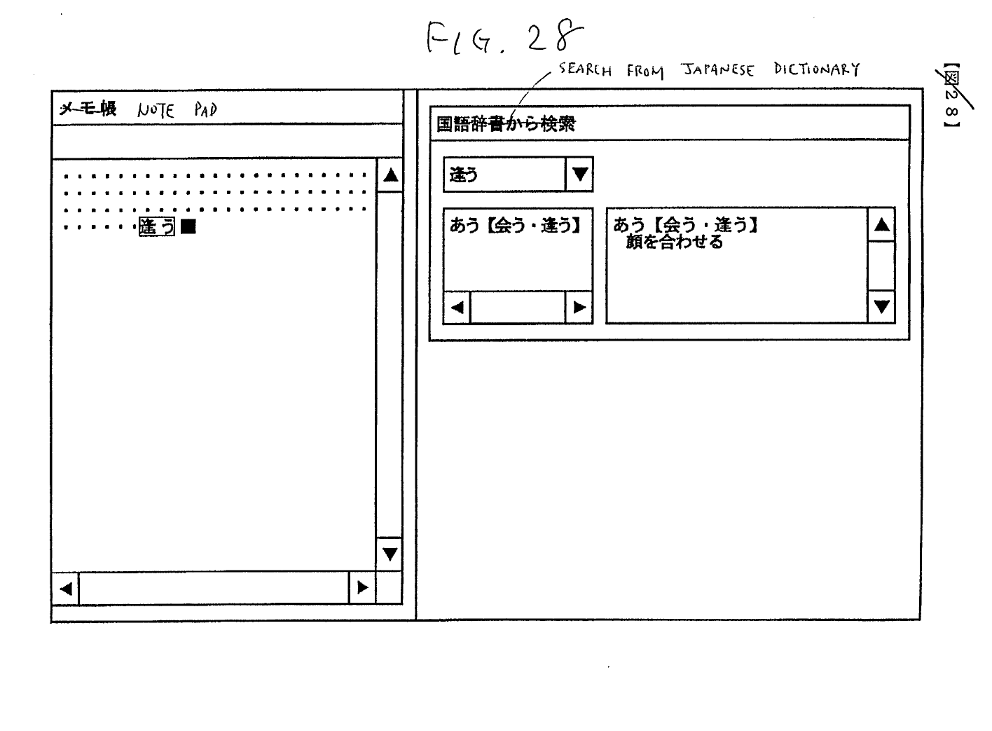

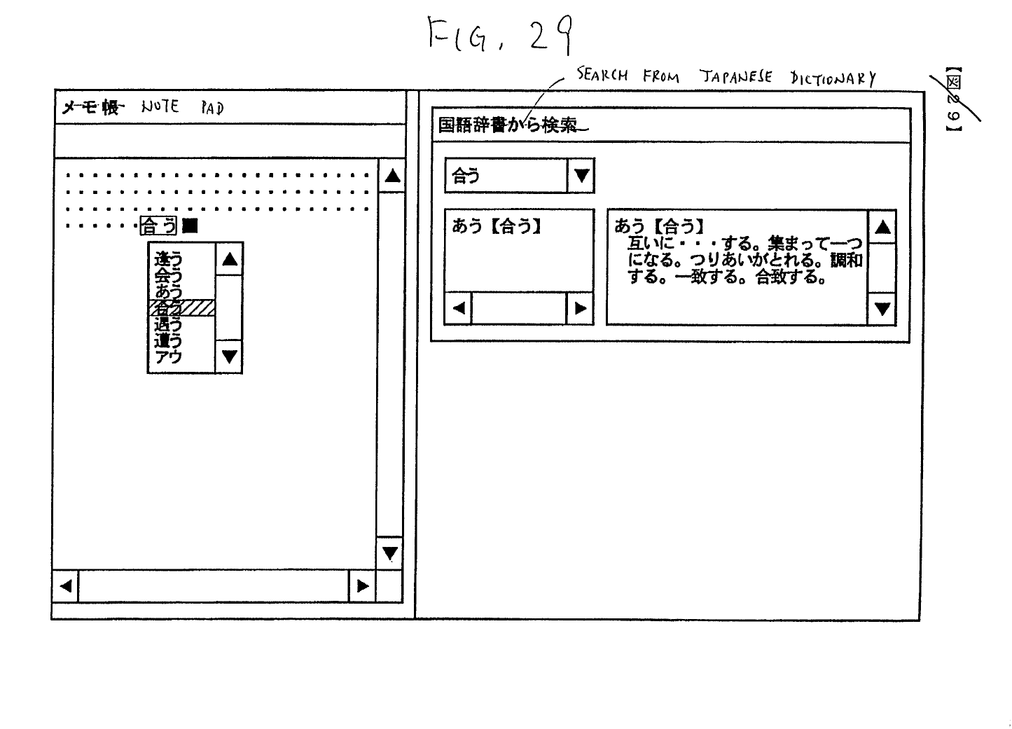

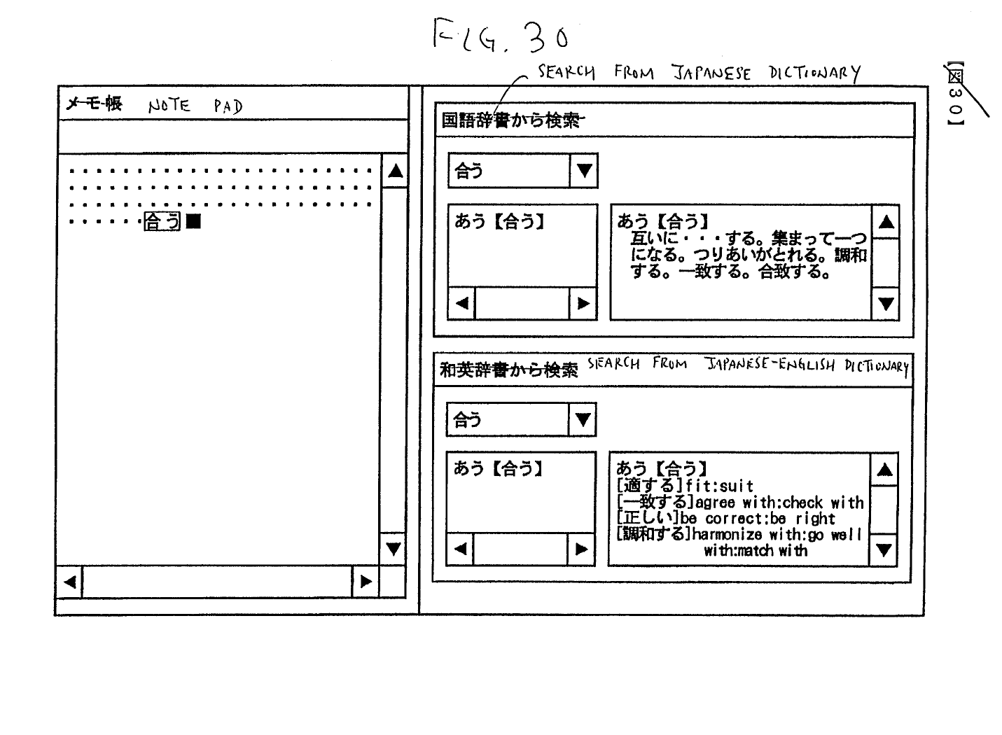

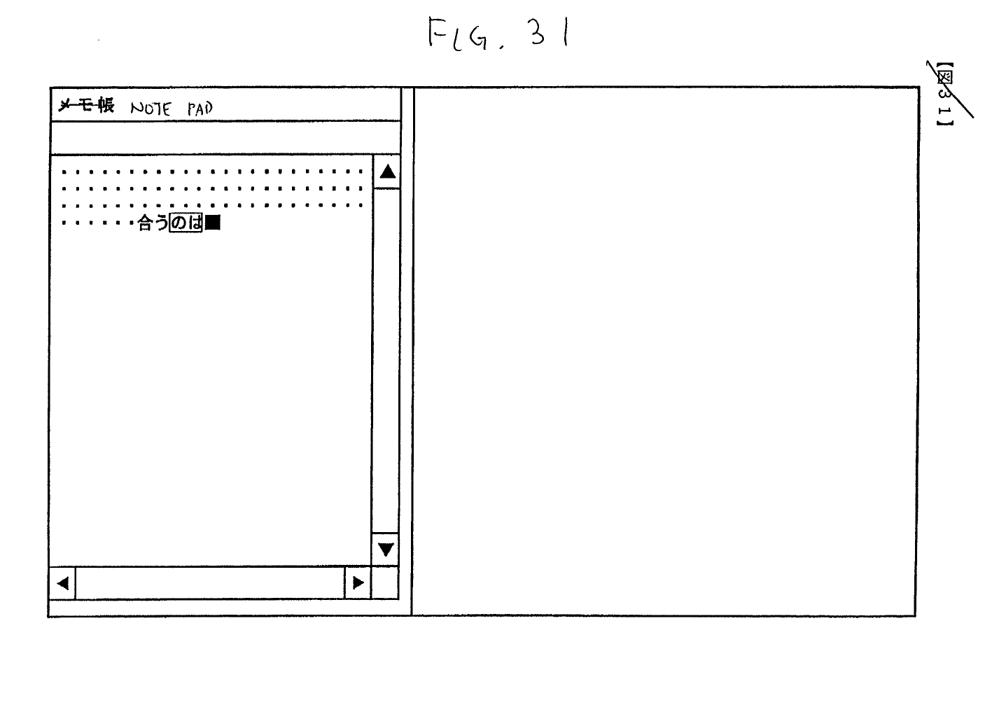

For example, when the undefined character string “ [symbol] ” (pronounced “au” and meaning “meet” in Japanese) is input and the menu item “look up Japanese dictionary” is selected on the bridge menu screen as shown in FIG. 27, a dictionary data of “ [symbol] ” is searched in the Japanese dictionary and displayed on the display screen as shown in FIG. 28.

Next, when the “conversion key” is pushed three times, for example, a character string “ [symbol] ” (pronounced “au” and meaning “match” in Japanese) is selected from a list of conversion candidates having the same pronunciation (“au”). As a result, a dictionary data of “ [symbol] ” is searched from the Japanese dictionary and displayed on the display screen in place of the dictionary data of “ [symbol] ” as shown in FIG. 29.

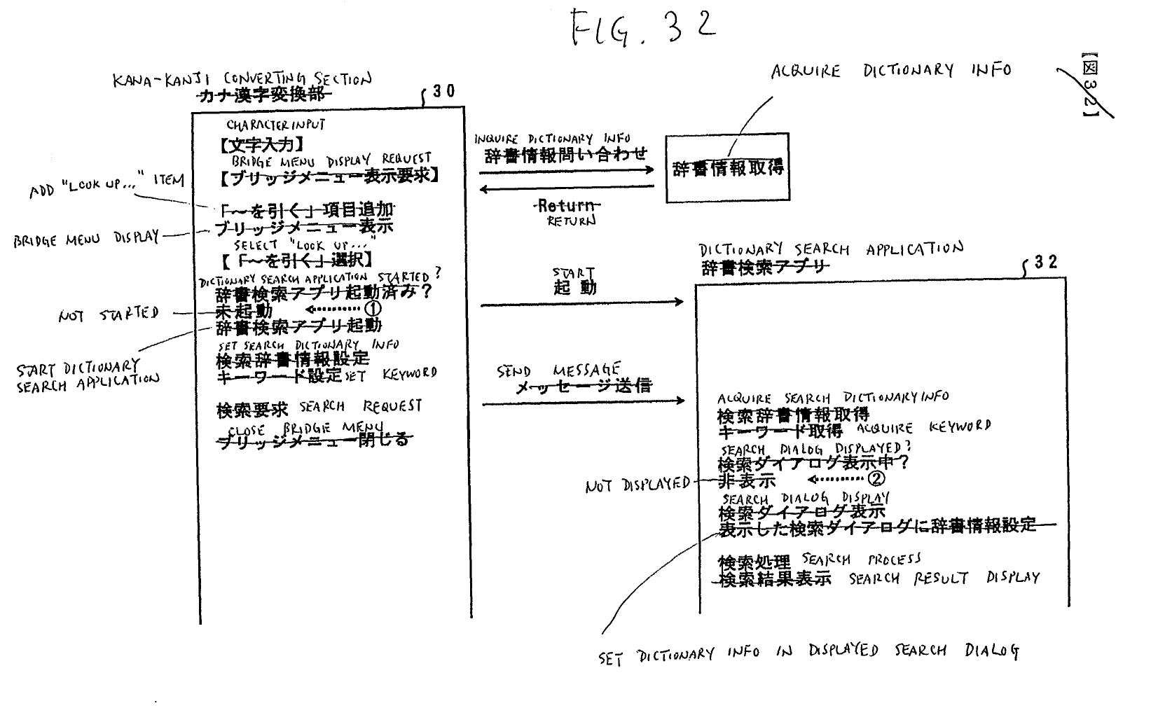

Then, when the menu item “look up Japanese-English dictionary” is selected, a dictionary data of “ [symbol] ” searched from the Japanese-English dictionary is displayed on the display screen, together with the dictionary data of “ [symbol] ” searched from the Japanese dictionary, as shown in FIG. 30. As shown in FIG. 30, the top right portion of the display screen shows the meanings of the character string “ [symbol] ” in Japanese, while the bottom right portion of the display screen shows the English translations of the character string “ [symbol] ”.

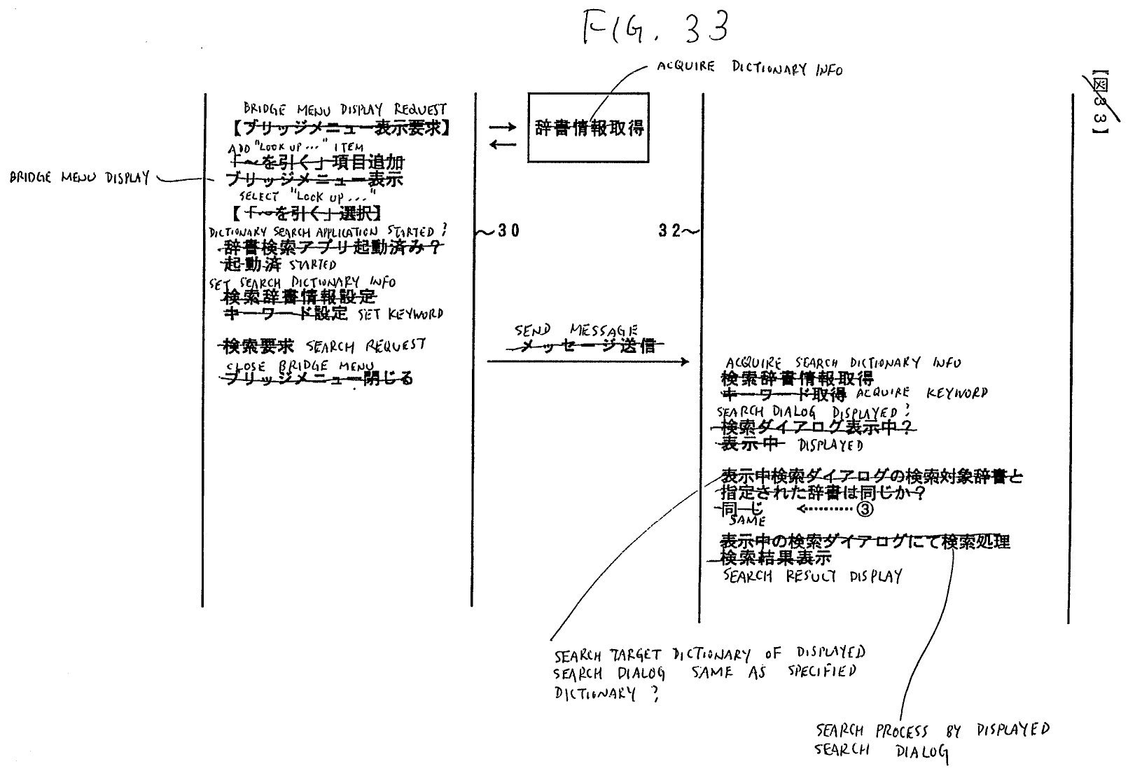

Further, when a character string “ [symbol] ” is input after the character string “ [symbol] ” to define the character string “ [symbol] ”, the dictionary search process of the dictionary search application 32 is ended as shown in FIG. 31.

As described above, the Kana-Kanji converting section 30 defines or cancels the input undefined character string in response to the input operation made by the user, and dictionary search process of the dictionary search application 32 is ended when the input undefined character string is defined or cancelled in this manner. However, the processes of the conversion programs such as the quick Japanese-English translation program may be ended similarly when the input undefined character string is defined or cancelled in response to the input operation made by the user. Accordingly, the user can end the process of the various programs (functions) by a simple operation.

Of course, the processes of the browsers 34 and 36, the mail software 38 and the programs 40 may be ended similarly when the input undefined character string is defined or cancelled in response to the input operation made by the user.

Next, a more detailed description will be given of the dictionary search process, by referring to FIGS. 32 through 35. FIGS. 32 through 35 respectively are diagrams for explaining the dictionary search process.

As shown in FIG. 32, when the dictionary in the list of “look up . . . ” on the bridge menu screen is selected, the Kana-Kanji converting section 30 judges whether or not the dictionary search application 32 is started. If it is judged that the dictionary search application 32 is not yet started, as indicated by \mathring{1} in FIG. 32, the Kana-Kanji converting section 30 starts the dictionary search application 32 before issuing a search request with respect to the dictionary search application 32.

In response to this search request, the dictionary search application 32 displays the search dialog if the search dialog is not displayed, and carries out the dictionary search process, as indicated by \mathring{2} in FIG. 32.

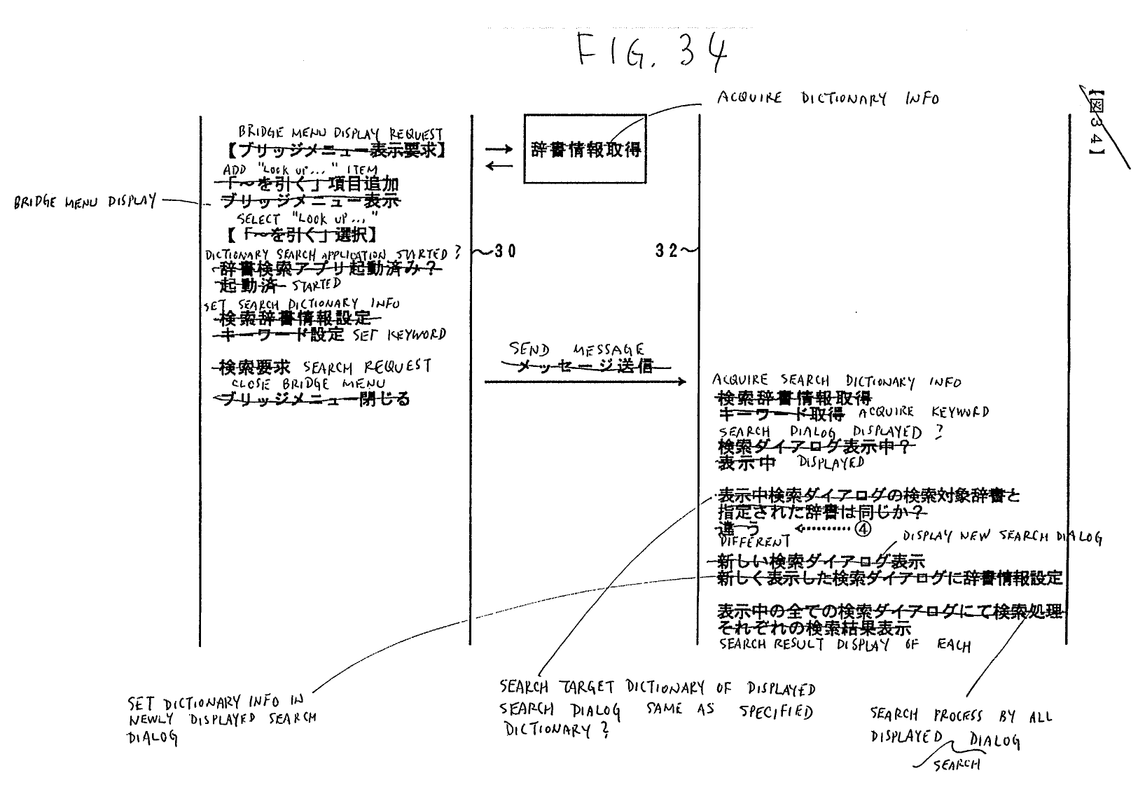

Next, as shown in FIG. 33, when the dictionary in the list of “look up . . . ” on the bridge menu screen is selected, the Kana-Kanji converting section 30 judges whether or not the dictionary search application 32 is started. If it is judged that the dictionary search application 32 is already started, the Kana-Kanji converting section 30 immediately issues a search request with respect to the dictionary search application 32.

In response to this search request, when the search dialog is being displayed, the dictionary search application 32 judges whether or not the dictionary information of the search target in the search dialog being displayed matches the dictionary information specified by the search request. If it is judged that the two dictionary information match as indicated by \mathring{3} in FIG. 33, the dictionary search process is carried out with the search dialog which is being displayed, and the search result is displayed.

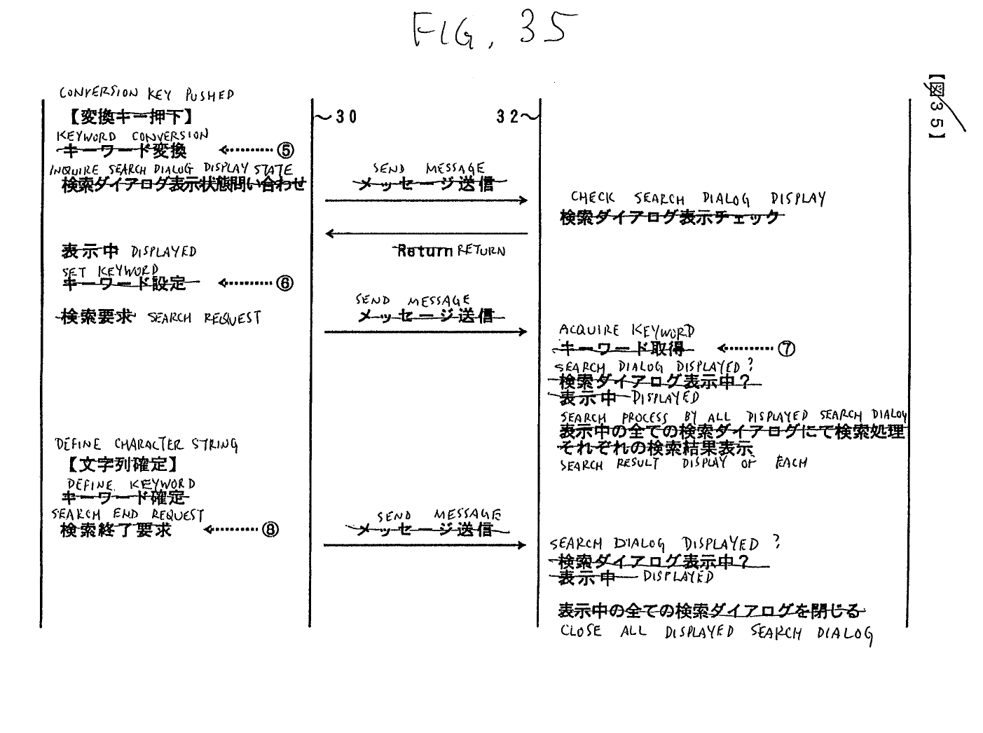

Then, as shown in FIG. 34, when the dictionary in the list of “look up . . . ” on the bridge menu screen is selected, the Kana-Kanji converting section 30 judges whether or not the dictionary search application 32 is started. If it is judged that the dictionary search application 32 is already started, the Kana-Kanji converting section 30 immediately issues a search request with respect to the dictionary search application 32.

In response to this search request, when the search dialog is being displayed, the dictionary search application 32 judges whether or not the dictionary information of the search target in the search dialog being displayed matches the dictionary information specified by the search request. If it is judged that the two dictionary information do not match as indicated by \mathring{4} in FIG. 34, a new search dialog is displayed, the dictionary search process is carried out with each search dialog which is being displayed, and the search result is displayed.

Thereafter, when the Kana-Kanji converting section 30 converts the keyword from Kana characters into Kanji characters in response to an input operation of the user as indicated by \mathring{5} in FIG. 35, the Kana-Kanji converting section 30 judges whether or not the search dialog is being displayed. If it is judged that the search dialog is being displayed, the Kana-Kanji converting section 30 sets the converted keyword as indicated by \mathring{6} in FIG. 35, and issues a search request with respect to the dictionary search application 32.

In response to this search request, the dictionary search application 32 acquires the converted keyword as indicated by \mathring{7} in FIG. 35, carries out the dictionary search process, and displays the search result.

Furthermore, when the keyword is defined in response to an input operation of the user, the Kana-Kanji converting section 30 issues a search end request with respect to the dictionary search application 32 as indicated by \mathring{8} in FIG. 35. The dictionary search application 32 closes each search dialog in response to the search end request, and the process ends.

Of course, the process of ending the program which is started according to the item specified on the bridge menu screen in the present invention includes the process of simply erasing the display of the program from the display screen. In other words, when ending other programs in the present invention, it is sufficient as long as the displays which interfere with the character input, such as the dialogs and windows displayed by the other programs which are started, are erased from the display screen.

In the embodiment described above, the computer has the Japanese language input and processing functions. However, the present invention is of course applicable to computers having the functions for inputting and processing other languages, such as the English language input and processing functions.

Moreover, the operation of the embodiment described above is given for the Japanese language processing, that is, Kana-Kanji conversion process. Hence, the input character string which forms the keyword is assumed to be in the undefined state until the conversion with respect to the input character string is defined. However, the present invention is of course not limited to such an application.

For example, in the case of the English language processing which does not require conversion of the input character string, the keyword may be specified as follows. That is, when the instruction to display the bridge menu screen is issued, a continuous character string from the present position of the cursor which is used to input the character up to a first space may be regarded as the keyword used in the present invention. The process of the present invention described above may be carried out similarly with respect to this English keyword. In addition, the operation to input the blank between the English words may be regarded as the operation of defining the input character string of the present invention.

Further, the present invention is not limited to these embodiments, but various variations and modifications may be made without departing from the scope of the present invention.

WHAT IS CLAIMED IS

1. A computer having a character input function, comprising:
a detecting section detecting a keyword which is specified by one or more input characters;
a display section displaying a menu screen indicating registered dictionaries when the keyword is detected by said detecting section; and
an issuing section issuing a search request for dictionary data specified by the keyword in a dictionary which is selected as a search target on the menu screen with respect to a dictionary search program.

2. The computer as claimed in claim 1, wherein said issuing section issues the search request for the dictionary data specified by the keyword, with respect to a plurality of dictionaries which are selected as search targets during a time when a define instruction is made to define the input characters.

3. The computer as claimed in claim 1, further comprising:
an ending section ending a started program in response to a selection made on the menu screen when a define instruction is made to define the input characters.

4. A computer having a character input function, comprising:
a detecting section detecting a keyword which is specified by one or more input characters;
a display section displaying a menu screen indicating registered programs when the keyword is detected by said detecting section; and
a starting section starting a program which is selected on the menu screen while specifying the keyword or an attribute value corresponding to the keyword as a parameter.

5. The computer as claimed in claim 4, further comprising:
a registering section registering data of a corresponding relationship of the keyword and the corresponding attribute value, according to an interactive process.

6. The computer as claimed in claim 4, wherein said display section displays a program which cannot be started by the keyword on the menu screen with a format which indicates that the program cannot be started.

7. The computer as claimed in claim 4, further comprising:
an ending section ending a started program in response to a selection made on the menu screen when a define instruction is made to define the input characters.

8. A computer having a character input function, comprising:
a detecting section detecting a keyword which is specified by one or more input characters;
a display section displaying a menu screen used for starting a program corresponding to the keyword when the keyword is detected by said detecting section; and
a starting section starting the program corresponding to the keyword when a program start request is issued using the menu screen.

9. The computer as claimed in claim 8, further comprising:
a registering section registering data of a corresponding relationship of the keyword and the program, according to an interactive process.

10. The computer as claimed in claim 8, further comprising:
an ending section ending a started program in response to a selection made on the menu screen when a define instruction is made to define the input characters.

11. A computer having a character input function, comprising:
a detecting section detecting a keyword which is specified by one or more input characters;
a display section displaying a menu screen indicating registered conversion programs when the keyword is detected by said detecting section; and
a starting section starting a conversion program which is selected using the menu screen to subject the keyword to a conversion according to the selected conversion program.

12. The computer as claimed in claim 11, wherein said display section displays a conversion program which cannot convert the keyword on the menu screen with a format which indicates that the program cannot convert.

13. The computer as claimed in claim 11, further comprising:
an ending section ending a started program in response to a selection made on the menu screen when a define instruction is made to define the input characters.

14. A computer having a character input function, comprising:
a detecting section detecting a keyword which is specified by one or more input characters;
a display section displaying a menu screen in response to a predetermined operation in a state where the keyword is detected by said detecting section; and
an executing section executing a process using the keyword depending on an item selected on the menu screen.

15. A method of carrying out a process depending on input characters, comprising the steps of:
(a) detecting a keyword which is specified by one or more input characters;
(b) displaying a menu screen indicating registered dictionaries when the keyword is detected by said step (a); and
(c) issuing a search request for dictionary data specified by the keyword in a dictionary which is selected as a search target on the menu screen with respect to a dictionary search program.

16. A method of carrying out a process depending on input characters, comprising the steps of:
(a) detecting a keyword which is specified by one or more input characters;
(b) displaying a menu screen indicating registered programs when the keyword is detected by said step (a); and
(c) starting a program which is selected on the menu screen while specifying the keyword or an attribute value corresponding to the keyword as a parameter.

17. A method of carrying out a process depending on input characters, comprising the steps of:
(a) detecting a keyword which is specified by one or more input characters;
(b) displaying a menu screen used for starting a program corresponding to the keyword when the keyword is detected by said step (a); and
(c) starting the program corresponding to the keyword when a program start request is issued using the menu screen.

18. A method of carrying out a process depending on input characters, comprising the steps of:
(a) detecting a keyword which is specified by one or more input characters;
(b) displaying a menu screen indicating registered conversion programs when the keyword is detected by said step (a); and
(c) starting a conversion program which is selected using the menu screen to subject the keyword to a conversion according to the selected conversion program.

19. A method of carrying out a process depending on input characters, comprising the steps of:
(a) detecting a keyword which is specified by one or more input characters;
(b) displaying a menu screen in response to a predetermined operation in a state where the keyword is detected by said step (a); and
(c) executing a process using the keyword depending on an item selected on the menu screen.

20. A computer-readable storage medium which stores a character input program for causing a computer to have a character input function, said character input program comprising:
a detecting procedure causing the computer to detect a keyword which is specified by one or more input characters;
a display procedure causing the computer to display a menu screen indicating registered dictionaries when the keyword is detected by said detecting procedure; and
an issuing procedure causing the computer to issue a search request for dictionary data specified by the keyword in a dictionary which is selected as a search target on the menu screen with respect to a dictionary search program.

21. A computer-readable storage medium which stores a character input program for causing a computer to have a character input function, said character input program comprising:
a detecting procedure causing the computer to detect a keyword which is specified by one or more input characters;
a display procedure causing the computer to display a menu screen indicating registered programs when the keyword is detected by said detecting procedure; and
a starting procedure causing the computer to start a program which is selected on the menu screen while specifying the keyword or an attribute value corresponding to the keyword as a parameter.

22. A computer-readable storage medium which stores a character input program for causing a computer to have a character input function, said character input program comprising:
a detecting procedure causing the computer to detect a keyword which is specified by one or more input characters;
a display procedure causing the computer to display a menu screen used for starting a program corresponding to the keyword when the keyword is detected by said detecting procedure; and
a starting procedure causing the computer to start the program corresponding to the keyword when a program start request is issued using the menu screen.

23. A computer-readable storage medium which stores a character input program for causing a computer to have a character input function, said character input program comprising:
a detecting program causing the computer to detect a keyword which is specified by one or more input characters;
a display procedure causing the computer to display a menu screen indicating registered conversion programs when the keyword is detected by said detecting procedure; and
a starting procedure causing the computer to start a conversion program which is selected using the menu screen to subject the keyword to a conversion according to the selected conversion program.

24. A computer-readable storage medium which stores a character input program for causing a computer to have a character input function, said character input program comprising:
a detecting procedure causing the computer to detect a keyword which is specified by one or more input characters;
a display procedure causing the computer to display a menu screen in response to a predetermined operation in a state where the keyword is detected by said detecting procedure; and
an executing procedure causing the computer to execute a process using the keyword depending on an item selected on the menu screen.
